(19) United States
(12) Patent Application Publication
(10) Pub. No.: US 2015/0256877 A1
(43) Pub. Date: Sep. 10, 2015

(54) METHOD FOR PROVIDING ADVERTISEMENT DATA

(71) Applicant: Panasonic Intellectual Property Corporation of America, Torrance, CA (US)

(72) Inventors: AKI YONEDA, Hyogo (JP); YASUSHI UESAKA, Hyogo (JP); YOSHIAKI OHSUMI, Hyogo (JP); DAISUKE MORI, Kanagawa (JP); YUKA OZAWA, Osaka (JP)

(21) Appl. No.: 14/715,598

(22) Filed: May 19, 2015

Related U.S. Application Data
(63) Continuation of application No. PCT/JP2014/004199, filed on Aug. 18, 2014.

(30) Foreign Application Priority Data
Sep. 13, 2013 (JP) 2013-191003
Jul. 10, 2014 (JP) 2014-141952

(51) Int. Cl. H04N 21/431; H04N 21/235; H04N 21/25; H04N 21/2668; H04N 21/81; G06Q 30/02; H04N 21/258

(52) U.S. Cl. CPC H04N 21/4316; G06Q 30/0269; H04N 21/235; H04N 21/25891; H04N 21/2668; H04N 21/812; H04N 21/251

(57) ABSTRACT

An advertisement ID and a personal ID are received from a video playback apparatus, personal information corresponding to the user ID is obtained from a first data base that manages at least one piece of personal information, advertisement information corresponding to the advertisement ID is obtained using a second data base that manages at least one piece of advertisement information, the advertisement information is used for generating superimposition advertisement data, which is superimposed upon the advertisement data, first superimposition advertisement data is generated using the personal information and the advertisement information, and the first superimposition advertisement data is provided to the video playback apparatus through a network in order to cause the video playback apparatus to play back the advertisement data upon which the first superimposition data is superimposed.

### BACKGROUND

1. Technical Field

The present invention relates to a method for providing advertisement data, the method providing an advertisement for a video playback apparatus such as a television.

2. Description of the Related Art

In Japanese Unexamined Patent Application Publication No. 10-079711, a technique is described in which a plurality of commercial messages (CMs) transmitted from a broadcast station are saved to a terminal in advance, and, at a timing of a CM in a broadcast program, one of the plurality of saved CMs appropriate for a viewer is selected and played back.

In addition, in Japanese Unexamined Patent Application Publication No. 2002-171511, a technique is described in which timing information indicating a timing at which a CM is to be inserted into broadcast signals of television is stored, and if a reception unit receives the broadcast signals, the reception unit obtains a CM appropriate for a viewer using the Internet in accordance with the timing information and displays the CM synchronously with broadcasting.

In Japanese Unexamined Patent Application Publication No. 10-079711 and Japanese Unexamined Patent Application Publication No. 2002-171511, however, further improvements are required.

### SUMMARY

In one general aspect, the techniques disclosed here feature a method for providing advertisement data in an advertisement data generation system connected, through a network, to a video playback apparatus that plays back the advertisement data. The method includes receiving an advertisement identifier (ID) indicating the advertisement data and a user ID indicating a user relating to the video playback apparatus from the video playback apparatus through the network, obtaining first personal information corresponding to the user ID using a first database that manages at least one piece of personal information, obtaining first advertisement information corresponding to the advertisement ID using a second database that manages at least one piece of advertisement information, the advertisement information being used for generating superimposition advertisement data, which is superimposed upon the advertisement data, generating first superimposition advertisement data using the first personal information and the first advertisement information, and providing the first superimposition advertisement data to the video playback apparatus through the network in order to cause the video playback apparatus to play back the advertisement data upon which the first superimposition advertisement data is superimposed.

According to the aspect of the present disclosure, further improvements can be realized.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIGS. 1A to 1C are diagrams illustrating an overall configuration of an advertisement data providing system according to a first embodiment;

FIG. 2 is a diagram illustrating a detailed configuration of the advertisement data providing system according to the first embodiment;

FIG. 3 is a diagram illustrating an example of a television CM video displayed on a display section of a video playback unit;

FIG. 4 is a sequence diagram of a method for providing advertisement data used by the advertisement data providing system according to the first embodiment;

FIGS. 5A and 5B are diagrams illustrating an example of information included in advertisement information;

FIG. 6 is a diagram illustrating another mode of displaying a CM video upon which personalized information is superimposed;

FIGS. 7A to 7C are diagrams illustrating an example in which an estimated cost of an automobile is superimposed upon a television CM video for the automobile;

FIGS. 8A and 8B are diagrams illustrating an example of information included in the advertisement information at a time when the estimated cost of the automobile is superimposed upon the television CM video for the automobile;

FIGS. 9A to 9C are diagrams illustrating an example in which a maximum travel distance of an automobile is superimposed upon a television CM video for the automobile;

FIGS. 10A and 10B are diagrams illustrating an example of information included in the advertisement information at a time when the maximum travel distance of the automobile is superimposed upon the television CM video for the automobile;

FIGS. 11A to 11C are diagrams illustrating an example in which a video of an automobile according to preferences of a viewer is superimposed upon a television CM video for automobiles;

FIGS. 12A and 12B are diagrams illustrating a specific example of a method for extracting tastes and preferences;

FIGS. 13A to 13C are diagrams illustrating an example in which a map is superimposed upon a television CM video for an automobile dealer;

FIGS. 14A and 14B are diagrams illustrating a specific example of a method for generating a map;

FIGS. 15A and 15B are diagrams illustrating an example in which two or more pieces of personalized information are generated for one television CM video;

FIG. 16 is a diagram illustrating an example in which a message asking the viewer to register personal information is superimposed;

FIG. 17 is a diagram illustrating a detailed configuration of the advertisement data providing system according to the first embodiment;

FIGS. 18A and 18B are diagrams illustrating an example of a television CM video according to a second embodiment;

FIG. 19 is a sequence diagram of a method for providing advertisement data used by an advertisement data providing system according to the second embodiment;

FIGS. 20A and 20B are diagrams illustrating an example in which a map is superimposed upon the television CM video;

FIG. 21 is a diagram illustrating a method for generating personalized information in which viewing state information and positional information are used;

FIGS. 22A and 22B are diagrams illustrating another example of the television CM video according to the second embodiment;

FIG. 23 is a diagram illustrating a detailed configuration of an advertisement data providing system according to a third embodiment;

FIG. 24 is a diagram illustrating an example of a television CM video according to the third embodiment;

FIG. 25 is a first sequence diagram of a method for providing advertisement data used by the advertisement data providing system according to the third embodiment;

FIG. 26 is a second sequence diagram of the method for providing advertisement data used by the advertisement data system according to the third embodiment;

FIG. 27 is a diagram illustrating a detailed configuration of an advertisement data providing system in which a business owner and an advertising agency are separated from each other;

FIG. 28 is a first sequence diagram of a method for providing advertisement data used by the advertisement data providing system illustrated in FIG. 27;

FIG. 29 is a second sequence diagram of the method for providing advertisement data used by the advertisement data providing system illustrated in FIG. 27;

FIG. 30 is a diagram illustrating a specific example of alternative advertisement selection information;

FIG. 31 is a flowchart illustrating a method for selecting an alternative advertisement;

FIG. 32 is a flowchart illustrating a subroutine of the selection of the alternative advertisement;

FIGS. 33A to 33C are diagrams illustrating an example of a television CM video upon which an advertisement of another company is actively superimposed;

FIG. 34 is a diagram illustrating a specific example of the alternative advertisement selection information and the advertisement information;

FIG. 35 is a diagram illustrating Service Type 1 (in-house data center type);

FIG. 36 is a diagram illustrating Service Type 2 (IaaS use type);

FIG. 37 is a diagram illustrating Service Type 3 (PaaS use type);

FIG. 38 is a diagram illustrating Service Type 4 (SaaS use type); and

FIG. 39 is a diagram illustrating a detailed configuration of an advertisement data providing system in which a cloud server obtains a personal ID and an advertisement ID.

### DETAILED DESCRIPTION

### Underlying Knowledge Forming Basis of the Present Disclosure

These days, more and more users of the Internet actively check information regarding interesting products or implicitly receive recommendation of products on the basis of their past search histories or purchase histories. Personalized advertising that utilizes ITs is advantageous compared to traditional advertising because a user can access more necessary information. In order to see Internet advertisements, however, the user generally needs to operate an information terminal such as a personal computer (PC) or a smartphone.

On the other hand, television CMs are advantageous in that the user can easily watch the television CMs without performing any operation only if the user turns on a television. Television CMs can reach more consumers than Internet advertisements. However, television CMs are not personalized. Consumers are tired of uninteresting CMs, and Internet advertisements are attracting attention.

Under these circumstances, as disclosed in Japanese Unexamined Patent Application Publication No. 10-079711 and Japanese Unexamined Patent Application Publication No. 2002-171511, new advertising techniques that can offer the personalization of Internet advertisements and the convenience of television CMs are known.

If the techniques disclosed in Japanese Unexamined Patent Application Publication No. 10-079711 and Japanese Unexamined Patent Application Publication No. 2002-171511 are put into practice, however, some difficulties arise.

Normally, advertisers pay television stations to place television CMs, and this is how the television stations manage their businesses. The advertisers naturally check if the CMs made as contracted are reaching viewers, and the broadcast stations try to make the viewers watch the CMs as requested by the advertisers.

In this situation, it is unlikely that advertisers and television stations adopt the above techniques because if CMs can be arbitrarily replaced in accordance with the viewers' preferences as in the background art, the advertisers and the television stations suffer significant losses. Therefore, it is extremely difficult to put the techniques disclosed in Japanese Unexamined Patent Application Publication No. 10-079711 and Japanese Unexamined Patent Application Publication No. 2002-171511 into practice.

Therefore, the inventors have established a method for superimposing information customized in accordance with the viewers' personal information upon broadcast television CMs, not replacing the television CMs.

A method for providing advertisement data according to an aspect of the present invention is a method for providing advertisement data in an advertisement data generation system connected, through a network, to a video playback apparatus that plays back the advertisement data. The method includes receiving an advertisement ID indicating the advertisement data and a user ID indicating a user relating to the video playback apparatus from the video playback apparatus through the network, obtaining first personal information corresponding to the user ID using a first database that manages at least one piece of personal information, obtaining first advertisement information corresponding to the advertisement ID using a second database that manages at least one piece of advertisement information, the advertisement information being used for generating superimposition advertisement data, which is superimposed upon the advertisement data, generating first superimposition advertisement data using the first personal information and the first advertisement information, and providing the first superimposition advertisement data to the video playback apparatus through the network in order to cause the video playback apparatus to play back the advertisement data upon which the first superimposition advertisement data is superimposed.

Thus, according to the method for providing advertisement data, the advertisement data is not replaced, but the information customized in accordance with the personal information is superimposed upon the advertisement data.

Because, for an advertiser, the advertisement data itself does not change, the advertiser can obtain a significant advertising effect by adding the information according to the personal information to a product to be advertised.

In addition, if the first personal information cannot be obtained using the first database, the first superimposition advertisement data may be generated only from the first advertisement information.

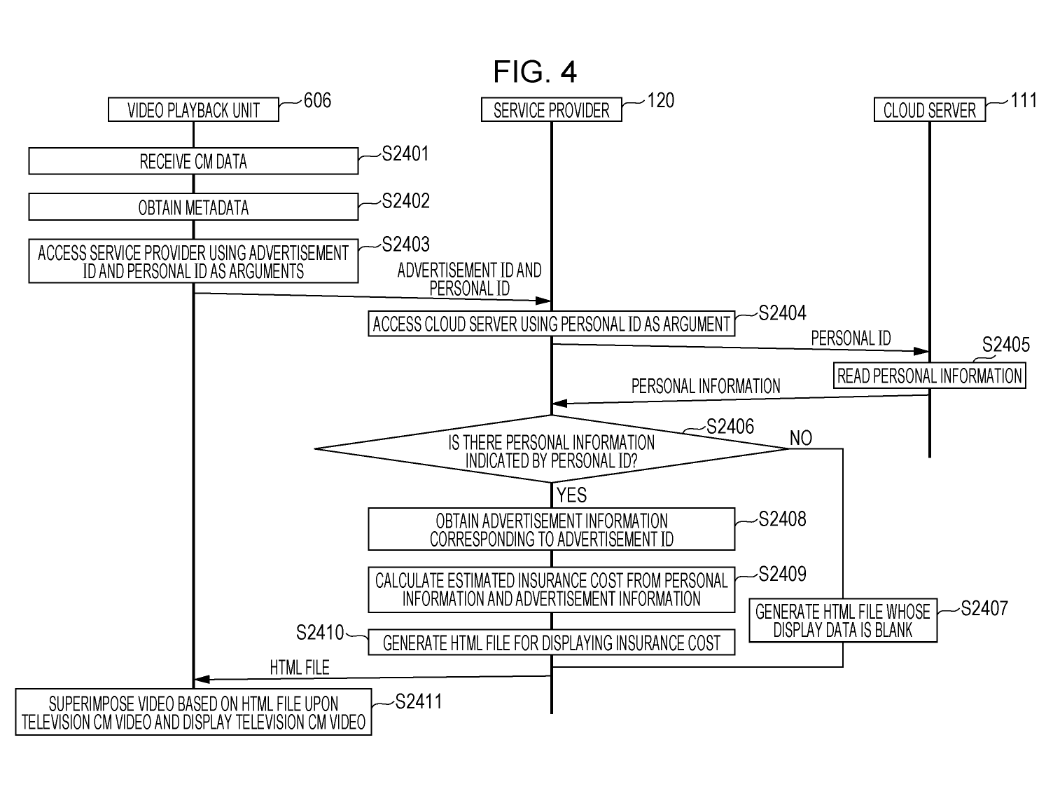

As a result, the advertisement data can be played back by the video playback apparatus even if the personal information is not registered in advance. It is to be noted that such a process corresponds to step S2407 illustrated in FIG. 4.

In addition, the first superimposition advertisement data may include a value relating to an advertising target of the advertisement data. The value may be calculated on the basis of the first personal information.

As a result, since the specific value according to the personal information is superimposed upon the advertisement data, the advertising effect can be improved.

In addition, the advertising target may be automobile insurance. The value may indicate an estimated cost of the automobile insurance for an automobile owned by the user.

In addition, the first personal information may include at least one of following pieces of information: age of the user, a color of a driver's license of the user, and a main purpose of use when the user uses the automobile. The estimated cost of the automobile insurance may be calculated on the basis of at least one of following pieces of information included in the first personal information: a base insurance cost of the automobile insurance, the age of the user, the color of the driver's license of the user, and the main purpose of use when the user uses the automobile.

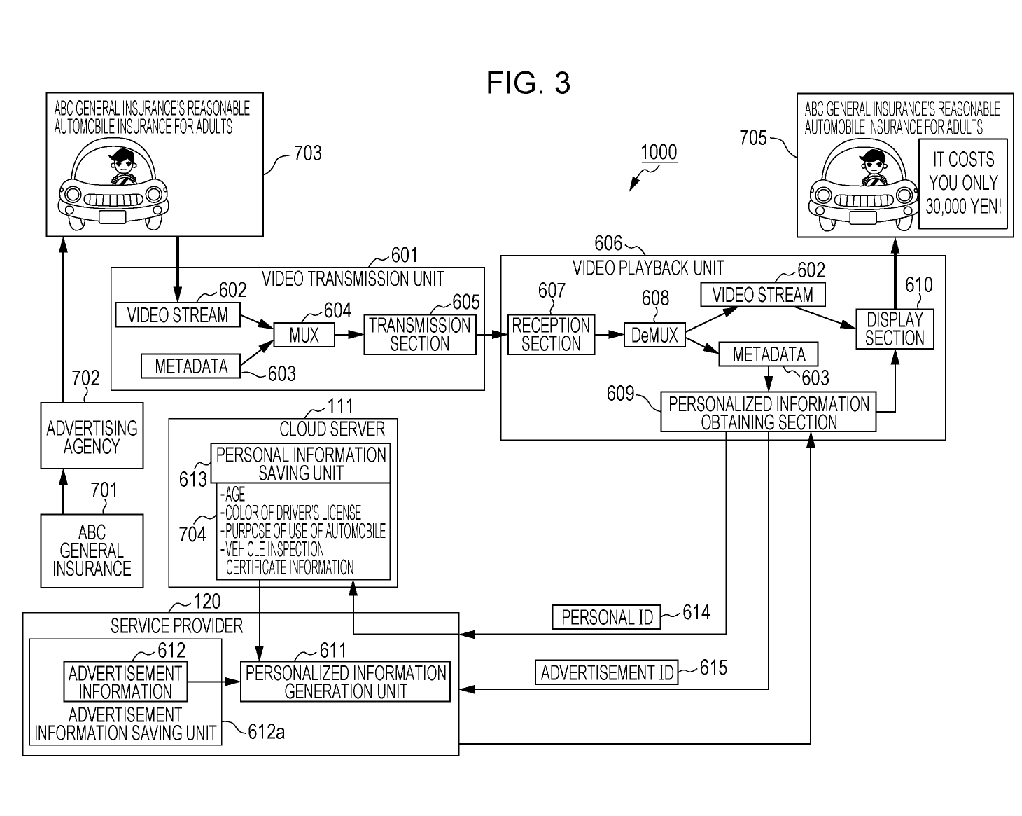

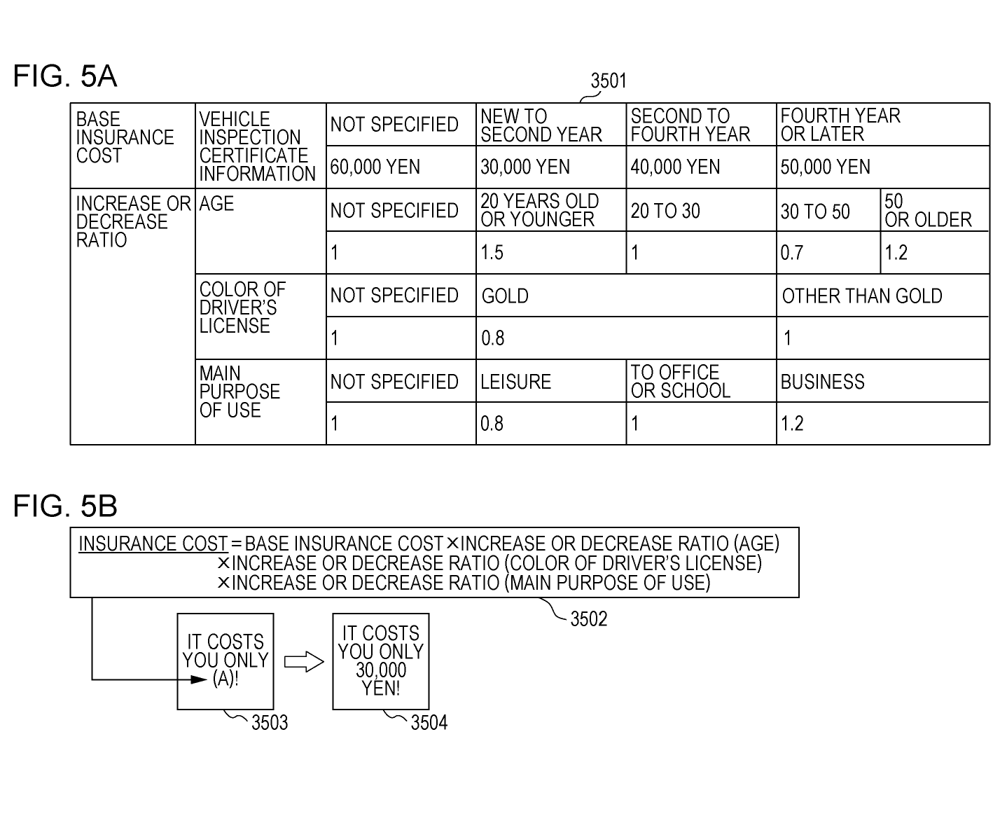

Thus, more specifically, the value superimposed upon the advertisement data is the estimated cost of the automobile insurance illustrated in FIG. 3, FIGS. 5A and 5B, or the like.

In addition, the advertising target may be an automobile. The value may indicate a purchase cost at a time when the user purchases the automobile that is the advertising target.

In addition, the first personal information may include at least one of following pieces of information: a make and a model of an automobile owned by the user, a travel distance of the automobile owned by the user, a history of automobile accidents of the user, and a state of scratches of the automobile owned by the user. The purchase cost may be calculated on the basis of at least one of following pieces of information included in the first personal information: a base trade-in price corresponding to the make and the model of the automobile owned by the user, the travel distance of the automobile owned by the user, the history of automobile accidents of the user, and the state of scratches of the automobile owned by the user.

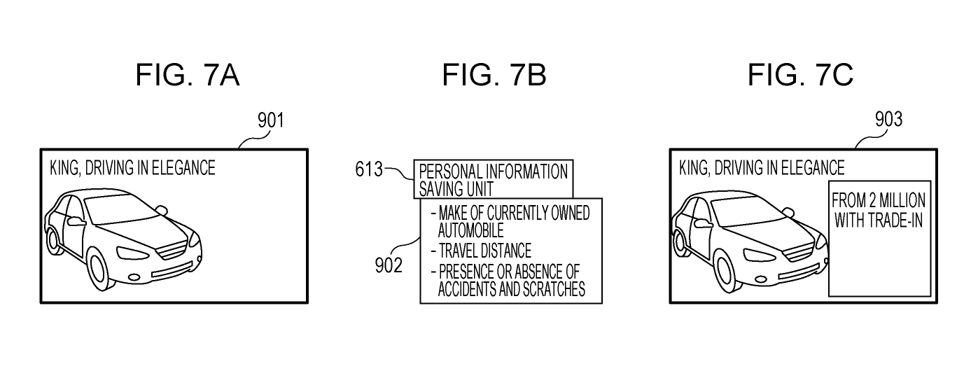

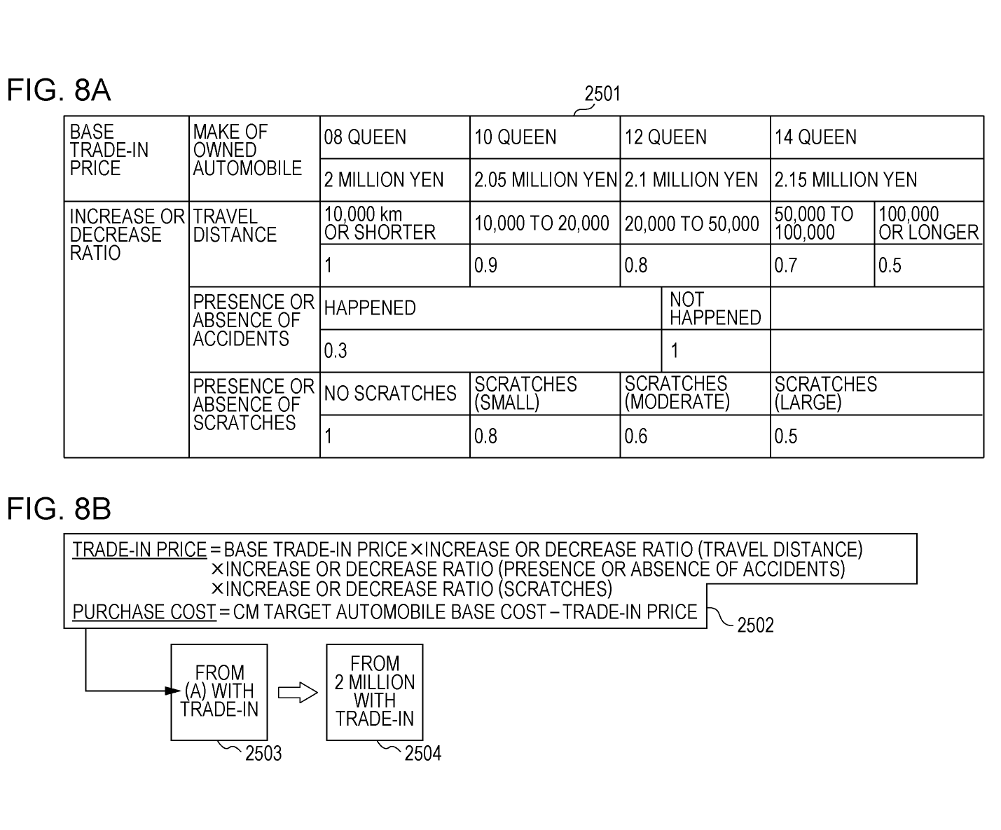

Thus, more specifically, the value superimposed upon the advertisement data is the purchase cost of the automobile illustrated in FIGS. 7A to 7C, FIGS. 8A and 8B, or the like.

In addition, the advertising target may be an automobile. The value may indicate a predicted value of an improvement in a travel distance at a time when the user replaces the automobile owned by the user with the automobile that is the advertising target.

In addition, the first personal information may be a make and a model of the automobile owned by the user. The predicted value of the improvement in the travel distance may be calculated on the basis of a maximum travel distance of the automobile that is the advertising target and a maximum travel distance of the automobile owned by the user.

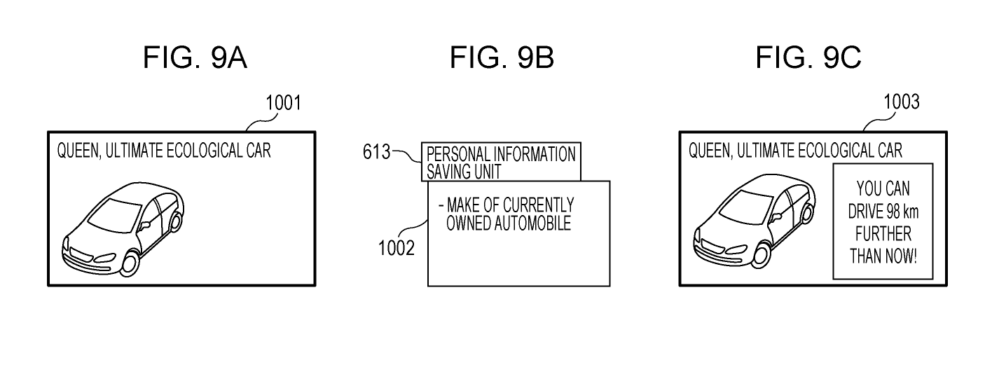

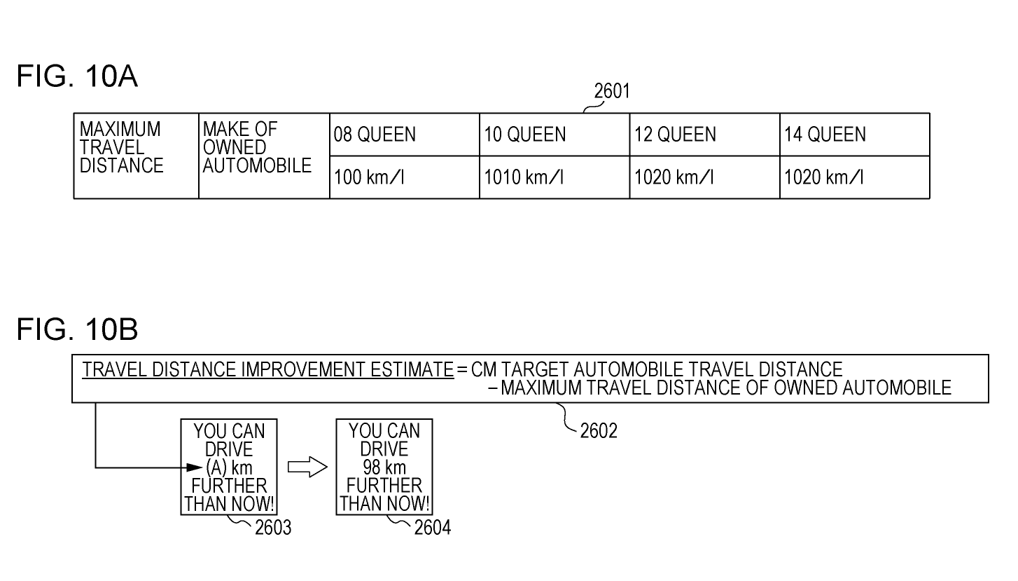

Thus, more specifically, the value superimposed upon the advertisement data is the maximum travel distance (fuel efficiency) of the automobile illustrated in FIGS. 9A to 9C, FIGS. 10A and 10B, or the like.

In addition, an advertising target of the advertisement data may include a plurality of types of articles. The first superimposition advertisement data may indicate one of the plurality of types of articles to be recommended to the user.

Thus, the method for providing advertisement data can determine various articles as advertising targets. It is to be noted that the articles here include not only movable property but also real estate (lands, houses, or the like).

In addition, the first personal information may include information regarding a type and a model number of a home appliance owned by the user and a television viewing history of the user. The article to be recommended to the user may be determined on the basis of the type and the model number of the home appliance owned by the user and the television viewing history of the user.

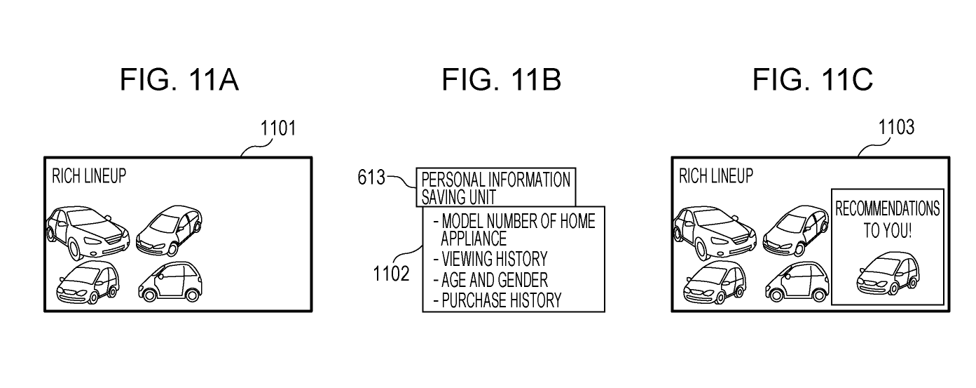

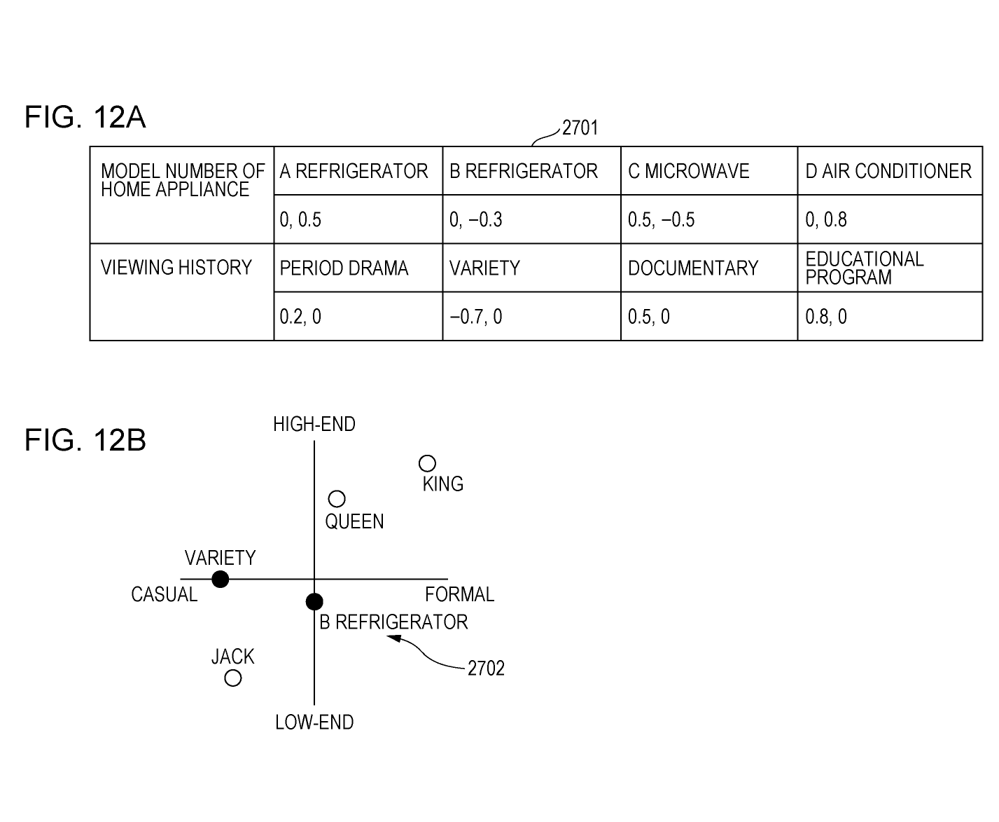

For example, if the article is an automobile, the model of the automobile to be recommended is determined on the basis of the grade of a home appliance or the like as illustrated in FIGS. 11 and 12.

In addition, an advertising target of the advertisement data may include a dealer. The store may include a plurality of local stores. The first superimposition advertisement data may indicate a name of one of the plurality of local stores nearest to the user's home and positional information regarding the nearest store.

In addition, the first personal information may include information regarding an address of the user's home. The nearest store may be selected on the basis of the address of the user's home. The positional information may be map information including a position of the nearest store on a map. Map information including the position of the nearest store may be obtained using a third database that manages map data.

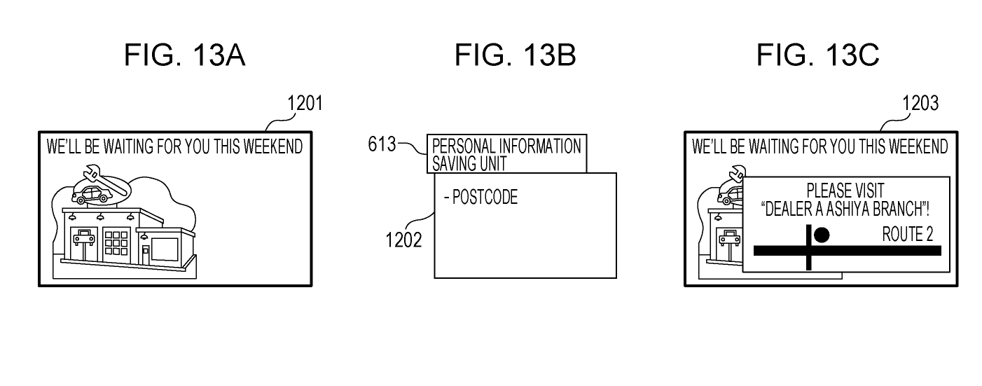

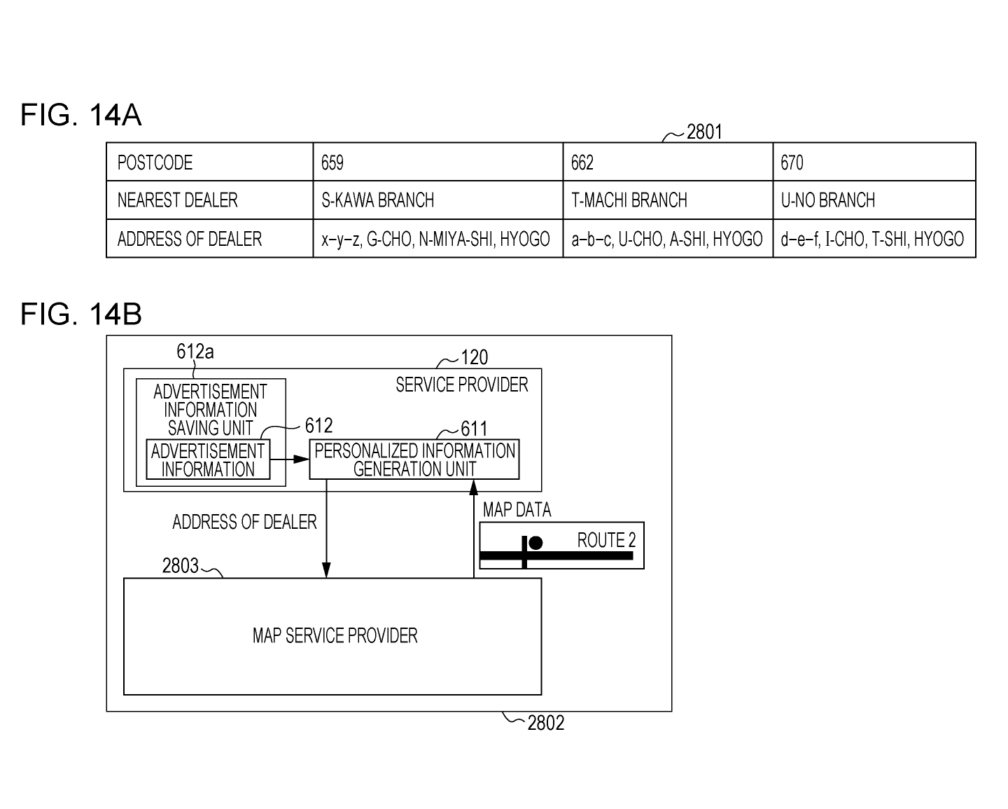

That is, as illustrated in FIGS. 13 and 14, the name of the nearest store and the positional information (map) regarding the nearest store may be superimposed upon the advertisement data.

In addition, a provider of the advertisement data and a provider of the superimposition advertisement data may be the same.

In addition, a provider of the advertisement data and a provider of the superimposition advertisement data may be different from each other.

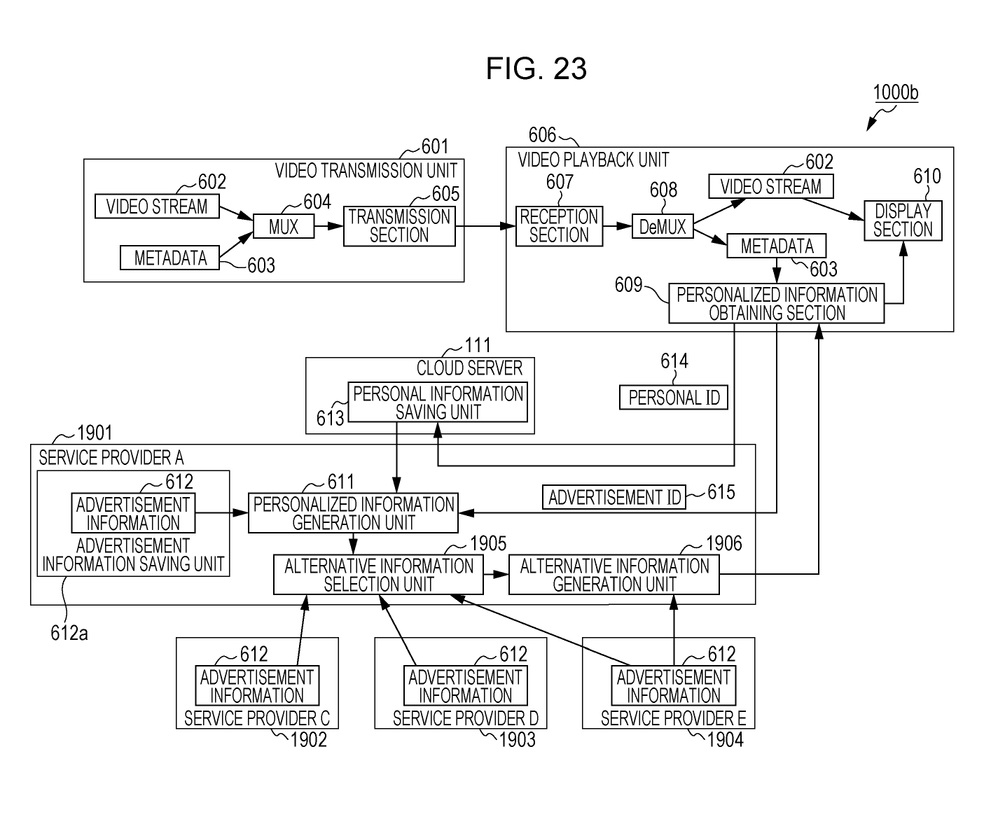

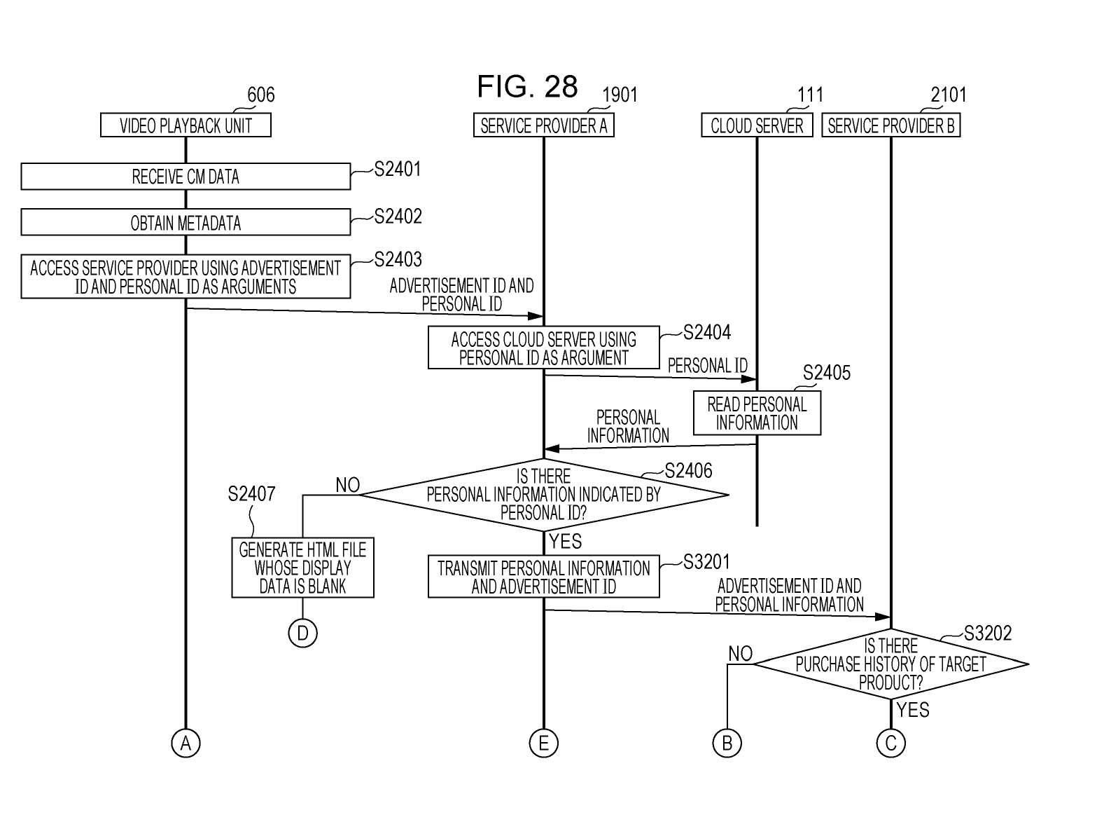

That is, as illustrated in FIGS. 23 and 28, the provider of the advertisement data may be a service provider A, and the provider of the superimposition advertisement data may be a service provider C, D, or E.

A method for providing advertisement data according to an aspect of the present invention may be a method for providing advertisement data in an advertisement data generation system connected, through a network, to a video playback apparatus that plays back the advertisement data. The method includes receiving an advertisement ID indicating the advertisement data and viewing state information including a time and a position at which the advertisement data is watched at the video playback apparatus, from the video playback apparatus through the network, obtaining first advertisement information corresponding to the advertisement ID using a first database that manages at least one piece of advertisement data, the advertisement information being used for generating superimposition advertisement data, which is superimposed upon the advertisement data, generating first superimposition advertisement data using the first advertisement information and the viewing state information, and providing the first superimposition advertisement data to the video playback apparatus through the network in order to cause the video playback apparatus to play back the advertisement data upon which the first superimposition advertisement data has been superimposed.

As a result, since the information according to a viewing state of a viewer is superimposed, the advertising effect can be improved.

In addition, the advertisement data may include first time information regarding an advertising target. The first superimposition advertisement data may include second time information regarding the advertising target. The first time information and the second time information may be different from each other.

In addition, the advertising target may include a dealer. The advertisement data may include information regarding a first event provided by the dealer and the first time information indicating a period in which the first event is provided. The first superimposition advertisement data may include information regarding a second event provided by the dealer and the second time information indicating a period in which the second event is provided. The first event and the second event may be different from each other.

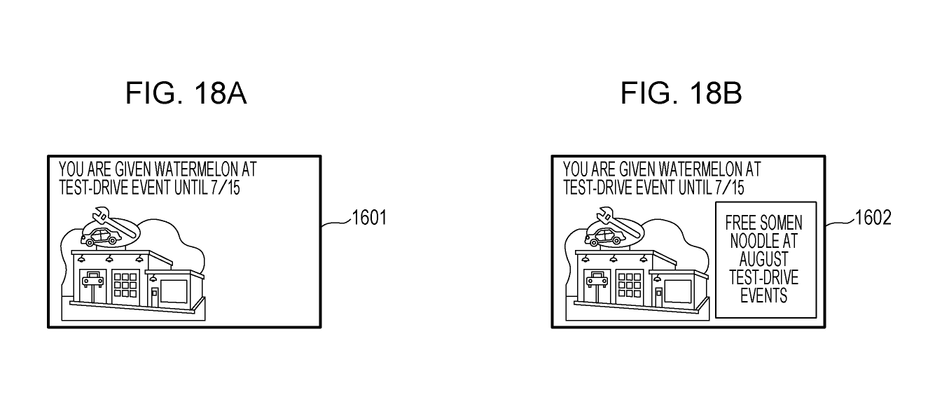

As a result, as illustrated in FIGS. 18A and 18B, the advertising effect of advertisement data whose advertising effect has decreased due to a difference in 1a viewing period can be improved.

In addition, the dealer may include a plurality of local stores. The first superimposition advertisement data may include a name of one of the plurality of local stores nearest to a point at which the advertisement data is watched and positional information regarding the nearest store.

In addition, the nearest store may be selected using the viewing state information. The positional information may be map information including a position of the nearest store on a map. The map information including the position of the nearest store may be obtained using a second database that manages map data.

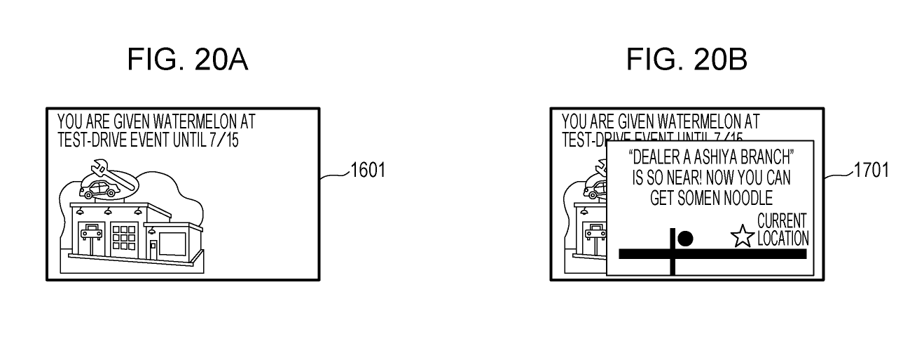

As a result, as illustrated in FIGS. 20A and 20B, even if the video playback apparatus is a tablet terminal or the like, it is possible to prompt the viewer to take purchase action since the map to the nearest store is displayed in accordance with a viewing position.

In addition, the method for providing advertisement data may further include receiving, from the video playback apparatus through the network, a user ID indicating a user relating to the video playback apparatus from the video playback apparatus through the network, obtaining first personal information corresponding to the user ID using a third database that manages at least one piece of personal information, and generating the first superimposition advertisement data using the first personal information.

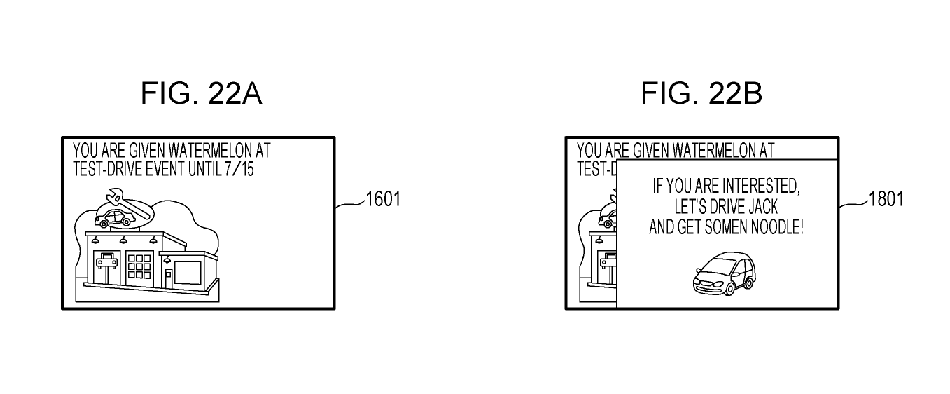

As a result, as illustrated in FIGS. 22A and 22B, the advertising effect can be improved since not only the map but also the information according to the personal information is superimposed upon the advertisement data.

In addition, the dealer may be an automobile dealer.

It is to be noted that these comprehensive or specific aspects may be realized by systems, methods, integrated circuits, computer programs, or computer-readable recording media such as compact-disc read-only memories (CD-ROMs). Alternatively, these comprehensive or specific aspects may be realized by arbitrary combinations of systems, methods, integrated circuits, computer programs, or recording media.

It is to be noted that embodiments that will be described hereinafter are specific examples of the present invention. Values, shapes, components, steps, order of the steps, and the like mentioned in the following embodiments are examples and are not intended to limit the present invention. In addition, among the components that will be described in the following embodiments, components that are not described in independent claims, which define broadest concepts, are described as arbitrary components. In addition, the content of all the embodiments may be combined with one another.

### First Embodiment

### Overall Configuration

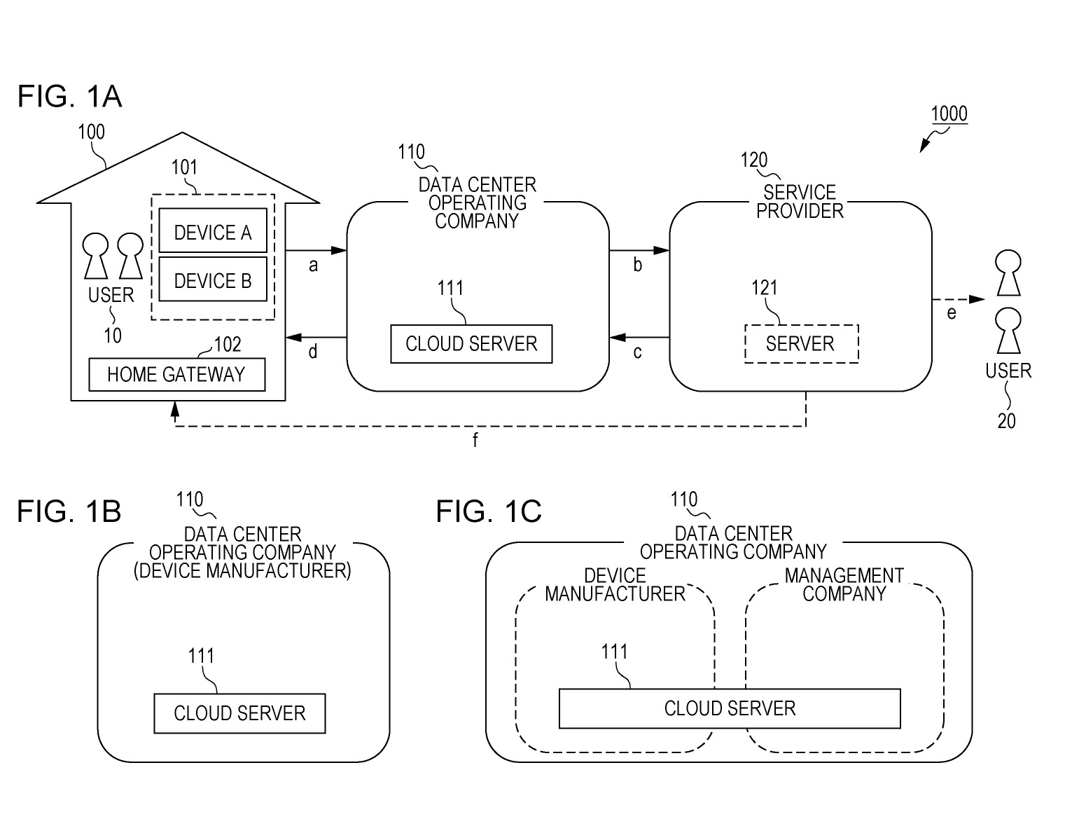

First, an overall configuration of an advertisement data providing system according to a first embodiment will be described. FIGS. 1A to 1C are diagrams illustrating the overall configuration of the advertisement data providing system according to the first embodiment.

As illustrated in FIG. 1A, an advertisement data providing system 1000 includes a group 100, a data center operating company 110, and a service provider 120.

The group 100 is, for example, a company, an organization, a household, or the like of any magnitude. The group 100 includes Device A and Device B, which are a plurality of devices 101 including a television, an air conditioner, a washing machine, and a microwave in a household, and a home gateway 102. The plurality of devices 101 include devices (for example, the television) that can be connected to the Internet and devices (for example, the air conditioner and the like) that cannot be connected to the Internet by themselves. Even the devices that cannot be connected to the Internet by themselves may be connected to the Internet through the home gateway 102. The group 100 also includes users 10 who use the plurality of devices 101.

The data center operating company 110 includes a cloud server 111. The cloud server 111 is a virtual server that cooperates with various devices through the Internet. The cloud server 111 mainly manages big data that is difficult to handle with a common database management tool or the like. The data center operating company 110, for example, manages data and the cloud server 111 and operates a data center. Details of operations of the data center operating company 110 will be described later.

Here, the data center operating company 110 is not limited to a company that only manages the data and operates the cloud server 111 and the like. For example, if a device manufacturer that develops and manufactures one of the plurality of devices 101 also manages the data, the cloud server 111, and the like, such a device manufacturer corresponds to the data center operating company 110 (FIG. 1B). In addition, the data center operating company 110 is not necessarily one company. For example, if a device manufacturer and another management company jointly or cooperatively manage the data and the cloud server 111, both the device manufacturer and the other management company or either the device manufacturer or the other management company is the data center operating company 110 (FIG. 1C).

The service provider 120 owns a server 121. The server 121 here may be of any magnitude and, for example, may be a memory of a PC for personal use or the like. In addition, the service provider might not own the server 121.

It is to be noted that the home gateway 102 is not necessarily needed. For example, if the cloud server 111 manages all the data, the home gateway 102 is unnecessary. In addition, as in a case in which all the devices in a household are connected to the Internet, there might be no devices that cannot be connected to the Internet by themselves.

Next, transmission of information in the system will be described.

First, Device A or Device B of the group 100 transmits log information to the cloud server 111 of the data center operating company 110. The cloud server 111 accumulates the log information from Device A or Device B ((a) in FIG. 1A). Here, log information refers to information regarding operations performed by the users 10 on the devices, information input by the users 10 to the devices, or the like obtained by the plurality of devices 101. For example, when a user 10 uses a VOD service on the television, the user 10 operates the television to input his/her personal information. Such personal information may be accumulated as the log information.

Furthermore, a date and a time when the user 10 turned on the television are included in the log information, and a time when the user 10 turned off the television, a time when the user 10 changed a channel, a time when the user 10 changed volume, and the like are all included in the log information. Furthermore, a time when the user 10 opened a door of a refrigerator, a time when the user 10 turned on the air conditioner, a time when the user 10 operated the microwave, and the like are included in the log information. The plurality of devices 101 might directly provide the log information for the cloud server 111 through the Internet. Alternatively, the plurality of devices 101 may temporarily accumulate the log information in the home gateway 102, and the home gateway 102 may then provide the log information for the cloud server 111.

Next, the cloud server 111 of the data center operating company 110 provides the accumulated log information for the service provider 120 in certain units. Here, the certain units may be units in which the data center operating company can sort out and provide the accumulated information for the service provider 120, or may be units requested by the service provider 120. In addition, although the term “certain units” has been used, the units need not be constant. The amount of information provided might change in accordance with a situation.

The log information is saved to the server 121 owned by the service provider 120 as necessary ((b) in FIG. 1A). The service provider 120 then sorts out the log information as information that suits a service provided for a user and provides the information for the user. That is, the user for which the information is provided may be the user 10 who uses the plurality of devices 101 or may be an external user 20. The service provided for the user may be directly provided for the user from the service provider ((e) and (f) in FIG. 1A).

Alternatively, the service provided for the user may be, for example, provided for the user through, again, the cloud server 111 of the data center operating company 110 ((c) and (d) in FIG. 1A). Alternatively, the cloud server 111 of the data center operating company 110 may sort out the log information as the information that suits the service provided for the user and provide the information for the service provider 120. It is to be noted that the user 10 and the user 20 may be the same or different from each other.

### Detailed Configuration

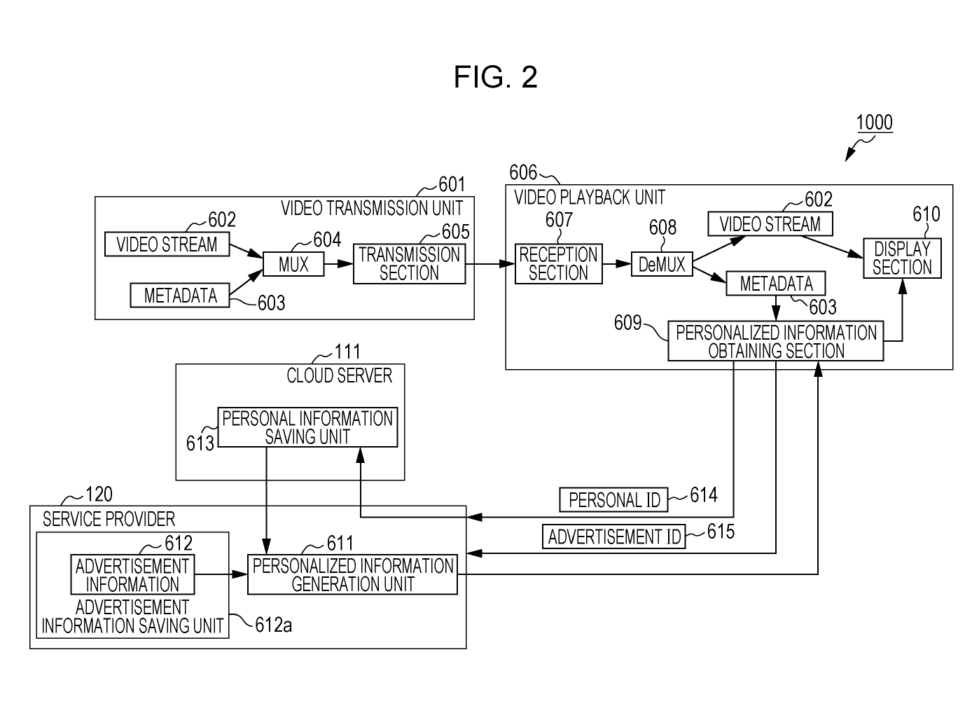

First, a detailed configuration of the advertisement data providing system 1000 according to the first embodiment will be described. FIG. 2 is a diagram illustrating the detailed configuration of the advertisement data providing system 1000 according to the first embodiment.

As illustrated in FIG. 2, the advertisement data providing system 1000 includes a video transmission unit 601, a video playback unit 606, the cloud server 111, and the service provider 120. It is to be noted that the service provider 120 is an example of an advertisement data generation system.

The video transmission unit 601 includes a multiplexer (MUX) 604 and a transmission section 605. More specifically, the video transmission unit 601 multiplexes a video stream 602 and metadata 603, which indicates the content of scenes included in the video stream 602, using the MUX 604 and transmits the multiplexed video stream 602 and metadata 603 from the transmission section 605.

For example, the video transmission unit 601 corresponds to a television broadcast station, and the transmission performed by the transmission section 605 corresponds to transmission of television broadcast radio waves. However, the video transmission unit 601 is not limited to this example. The video transmission unit 601 is, for example, a video distribution server, such as a VOD server, on a network and may transmit the video stream 602 through the Internet. That is, in FIGS. 1A to 1C, the video transmission unit 601 might be arranged outside the group 100.

The video stream 602 is, for example, a television program and includes a video (scenes) of the program itself such as a drama or news and a video (scenes) of CMs inserted in between.

The metadata 603 is data indicating the type of each scene included in the video stream 602 (whether a scene is a program or a CM, and if a scene is a CM, what kind of product the CM is about). For example, in order to define the content of a scene, the metadata 603 includes a playback time of the corresponding scene, a category (a program, a CM, or the like) of the scene, an ID indicating the content of the scene, and the like. If a scene is a television CM, the metadata 603 includes an advertisement ID 615. Details of the advertisement ID 615 will be described later.

The video stream 602 and the metadata 603 are multiplexed by the MUX 604. For example, if the video stream 602 is encoded as an MPEG-2 transport stream (TS), the metadata 603 is multiplexed as one of TS packets.

The video playback unit 606 is an example of a video playback apparatus and includes a reception section 607, a demultiplexer (DeMux) 608, a personalized information obtaining section 609, and a display section 610. The video playback unit 606 receives a video stream transmitted from the video transmission unit 601 and displays a video. The video playback unit 606 corresponds to a device such as a television, a PC, a smartphone, or a tablet. That is, the video playback unit 606 typically corresponds to one of the plurality of devices 101.

More specifically, the video playback unit 606 receives the video stream 602 and the metadata 603 using the reception section 607 and demultiplexes the video stream 602 and the metadata 603 using the demultiplexer (DeMux) 608.

The personalized information obtaining section 609 transmits a personal ID 614 (user ID) and the advertisement ID 615 to the service provider 120 using communication means such as the Internet in accordance with the metadata 603 obtained as a result of the demultiplexing. The personal ID 614 is an ID for identifying a viewer (user) of the video playback unit 606, and the advertisement ID 615 is an ID for identifying an advertisement included in the metadata 603. As a result of the transmission of the personal ID 614 and the advertisement ID 615, the personalized information obtaining section 609 obtains, for example, detailed information (personalized information) personalized in order to advertise a product in a television CM.

The personalized information (superimposition advertisement data) may be represented by a still image or a moving image. Alternatively, the personalized information may be a combination of a still image and a moving image. The personalized information may be a group of data or may be written in HyperText Markup Language (HTML) including a link to a still image file or a moving image file stored in a server connected to the Internet. It is to be noted that a specific example of the personalized information will be described.

The display section 610 decodes and displays the video stream 602 and displays the personalized information obtained by the personalized information obtaining section 609 synchronously with a scene identified by the metadata 603. More specifically, the display section 610 is a liquid crystal display (liquid crystal panel) or an organic electroluminescent (EL) display (organic EL panel).

The cloud server 111 corresponds to the cloud server 111 described with reference to FIGS. 1A to 1C. A personal information saving unit 613 (storage unit) of the cloud server 111 stores personal information regarding viewers. The personal information saving unit 613 is an example of a first database. The personal information saving unit 613 is, for example, an hard disk drive (HDD), but may be any storage device, such as a semiconductor memory.

In the description with reference to FIGS. 1A to 1C, the term “log information” has been used for referring to the information accumulated in the cloud server 111. The personal information in the first embodiment refers to information in the “log information” that can be used for personalizing advertisement information.

The personal information is stored, for example, using a markup language such as eXtensible Markup Language (XML) or by a database system. In addition, a method for obtaining personal information is not particularly limited. For example, personal information obtained by the service provider 120 at a predetermined timing may be saved to the personal information saving unit 613. In addition, personal information obtained by the data center operating company that operates the cloud server 111 may be saved to the personal information saving unit 613 using a certain method.

In addition, information obtained by the video playback unit 606 when the personal ID 614 (details will be described later) is registered may be transmitted from the video playback unit 606 to the personal information saving unit 613 at a particular timing. In addition, the cloud server 111 may be a server managed by the data center operating company 110 or a server managed by the service provider 120.

Furthermore, as illustrated in FIG. 2, the service provider 120 may directly communicate information with the video playback unit 606, or may communicate information through the data center operating company 110. In addition, in this case, the cloud server 111 may be managed by a television station that manages the video transmission unit 601.

The personal ID 614 is an ID for identifying a viewer who is watching a broadcast program using the video playback unit 606. The personal ID 614 is used for identifying one of a plurality of pieces of personal information stored in the personal information saving unit 613 regarding a target viewer.

The identification of a viewer is mainly performed by the video playback unit 606 (typically a television). For example, the viewer may input a user name before watching the television. The viewer may be identified by recognizing a face image of the viewer using a camera mounted on the television. Alternatively, the viewer may be identified by detecting a viewer's voice using a microphone mounted on the television and analyzing the viewer's voiceprint. Alternatively, a sofa, not the video playback unit 606, arranged in front of the video playback unit 606 may identify the viewer who has sat on the sofa by detecting weight using a pressure sensor or the like and issue the personal ID 614.

It is to be noted that a method for identifying a viewer is not limited to the above method. For example, if a unique ID is provided for each video playback unit 606, the viewer can be identified at least in a household on the basis of the unique ID. In addition, if the viewer is living alone, the viewer can be certainly identified using the unique ID. For example, a media access control (MAC) address of the video playback unit 606 may be used as the unique ID if the video playback unit 606 includes an interface to the Internet.

The advertisement ID 615 is stored in the metadata 603 and is, for example, an ID indicating the content of a television CM. For example, the advertisement ID 615 includes a business owner identifier and a CM identifier.

The business owner identifier is an identifier for identifying a business owner (manufacturer or the like) of a product advertised in a television CM. The business owner identifier is, for example, a uniform resource locator (URL) identifying a server on the Internet. Because of this URL, the service provider 120 operated by the advertiser (that is, the business owner of the target product) of the television CM can be identified. The CM identifier is an identifier for identifying, among television CMs handled by a business owner, a television CM to which the metadata 603 is added.

It is to be noted that the advertisement ID 615 may further include a display position specifier that specifies a position at which the personalized information is displayed.

The service provider 120 corresponds to the service provider 120 described with reference to FIGS. 1A to 1C. The service provider 120 receives the personal ID 614 and the advertisement ID 615 from the personalized information obtaining section 609 and generates personalized information. In addition, the service provider 120 transmits the generated personalized information to the personalized information obtaining section 609.

More specifically, the service provider 120 transmits the received personal ID 614 to the cloud server 111 and reads, among the pieces of personal information stored in the personal information saving unit 613, a piece of personal information regarding a person identified by the personal ID 614. Furthermore, the service provider 120 identifies a television CM using the received advertisement ID 615 and reads advertisement information 612 regarding a product advertised in the identified television CM from an advertisement information saving unit 612a. The advertisement information saving unit 612a is an example of a second database and may be any storage device, such as an HDD.

A personalized information generation unit 611 generates personalized information in accordance with the personal information and the advertisement information 612 and transmits the personalized information to the personalized information obtaining section 609.

### Method for Providing Advertisement Data

A specific operation (a method for providing advertisement data) of the advertisement data providing system 1000 configured in the above manner will be described with reference to FIGS. 3 and 4. FIG. 3 is a diagram illustrating an example of a television CM video displayed on the display section 610 of the video playback unit 606. FIG. 4 is a sequence diagram of the method for providing advertisement data used by the advertisement data providing system 1000. It is to be noted that description of content in FIG. 3 that has already been described with reference to FIG. 2 is omitted.

In FIG. 3, the advertiser is an ABC General Insurance 701, which is a business owner who deals in automobile insurance. In addition, the ABC General Insurance 701 operates the service provider 120.

First, the ABC General Insurance 701 requests an advertising agency 702 to produce a television CM and place the television CM on television. The advertising agency 702 creates a television CM video 703 (advertisement data) and requests the video transmission unit 601, which is a television station, to broadcast the television CM video 703. At this time, the video transmission unit 601 generates the metadata 603 including the business owner identifier (URL) identifying the service provider 120, the CM identifier identifying the television CM video 703, and the display position specifier identifying a position at which the personalized information is displayed on the display section 610 of the video playback unit 606.

On the other hand, as described above, the cloud server 111 manages, using the personal information saving unit 613, the personal information associated with the video playback unit 606. For example, a company that operates a network service for television, such as VOD, may operate the cloud server 111 and collect personal information by giving viewers questionnaires while providing services.

The ABC General Insurance 701 is in partnership with a company that operates the cloud server 111 and can use the personal information saved in the personal information saving unit 613. Furthermore, the ABC General Insurance 701 asks the viewers of the video playback unit 606 to input information necessary to roughly estimate the cost of the product thereof (automobile insurance) in advance, and this information is also stored in the cloud server 111. Information 704 illustrated in FIG. 3 is, among the pieces of information stored in the personal information saving unit 613, pieces of information necessary to estimate the cost of the automobile insurance. The information 704 includes the ages of the viewers, the colors of driver's licenses, and the like.

The video transmission unit 601 multiplexes the television CM video 703 and the metadata 603 and transmits the multiplexed television CM video 703 and metadata 603 as CM data. The video playback unit 606 receives the CM data included in television broadcasting (S2401), obtains the television CM video 703 and the metadata 603 by decoding the CM data (S2402).

The personalized information obtaining section 609 of the video playback unit 606 accesses the service provider 120 indicated by the URL included in the advertisement ID 615 included in the metadata 603. At this time, the personalized information obtaining section 609 accesses the service provider 120 using the advertisement ID and the personal ID 614 (the unique ID of the video playback unit 606 in the first embodiment) as arguments (S2403).

The service provider 120 accesses the cloud server 111, which is in partnership with the service provider 120, using the personal ID 614 obtained from the video playback unit 606 as an argument (S2404).

The cloud server 111 reads, from the personal information saving unit 613, personal information identified by the personal ID 614 obtained from the service provider 120 (S2405) and sends the personal information back to the service provider 120. As a result, the service provider 120 obtains the information 704 necessary to estimate the cost of the automobile insurance.

If the personal information saving unit 613 does not include personal information corresponding to the personal ID 614 (No in S2406), the service provider 120 generates an HTML file whose display data is blank (S2407).

If the personal information saving unit 613 includes personal information corresponding to the personal ID 614 (Yes in S2406), the service provider 120 identifies a target product advertised in the television CM video 703 using the CM identifier included in the advertisement ID 615 obtained from the video playback unit 606 and obtains the advertisement information 612 regarding the identified target product (S2408). Here, in FIG. 3, the target product is a type of automobile insurance, that is, “reasonable automobile insurance for adults”.

In addition, the advertisement information 612 includes evaluation criteria for estimating the cost of the automobile insurance. The evaluation criteria are, for example, evaluation criteria for evaluating items of personal information and estimating the cost of the automobile insurance (for example, how much the cost of the automobile insurance decreases depending on age). FIGS. 5A and 5B are diagrams illustrating an example of information included in the advertisement information 612.

As illustrated in FIGS. 5A and 5B, the advertisement information 612 includes evaluation criteria 3501, a calculation expression 3502, an HTML file 3503, and the like.

The evaluation criteria 3501 illustrated in FIG. 5A are part of the advertisement information 612. In the evaluation criteria 3501, an example of parameters for calculating the cost of the automobile insurance is indicated. In the example illustrated in FIG. 5A, a base insurance cost is determined on the basis of vehicle inspection certificate information (the number of days from when an automobile was purchased) included in the information 704, and ratios for increasing or decreasing the base insurance cost are determined on the basis of parameters, such as age, the color of the driver's license, and a main purpose of use, included in the information 704. That is, as in the calculation expression 3502 illustrated in FIG. 5B, the automobile insurance cost is determined by multiplying the base insurance cost and the increase or decrease ratio for each parameter (S3502).

The personalized information generation unit 611 estimates the cost of the automobile insurance on the basis of the calculation expression 3502 and the information 704 (S2409). Furthermore, an HTML file 3504 that displays the automobile insurance cost determined in step S2409 is generated in the HTML file 3503, which defines a basic display layout (S2410). More specifically, the HTML file 3504 is an HTML file that displays the cost of the automobile insurance at a position of (A) in the HTML file 3503. The generated HTML file 3504 corresponds to the above-described personalized information and is transmitted to the personalized information obtaining section 609.

The personalized information obtaining section 609 obtains the HTML file 3504, and the display section 610 displays a television CM video 705 in which a video based on the HTML file 3504 is superimposed upon the television CM video 703 (S2411).

According to the above-described method for providing advertisement data, detailed information (personalized information) regarding a product personalized in accordance with personal information regarding a viewer can be superimposed upon the television CM video 703.

Especially in the case of the CM for automobile insurance described with reference to FIGS. 3 and 4, even if an advertisement saying “reasonable for adults” is displayed, a viewer who is watching the advertisement cannot understand how reasonable it is for him/her, which is problematic.

A viewer who is interested in the television CM can check the insurance cost by, for example, inputting personal information to an estimation website on the Internet, but the viewer needs to temporarily stop watching television, which the viewer might hesitate about.

On the other hand, according to the above method for providing advertisement data, the viewer can check the estimated insurance cost (information relevant only to the viewer) just by watching television as usual, which is significantly effective.

It is to be noted that in the method for providing advertisement data, a viewer needs to provide (register) the information 704 necessary to estimate the cost of the automobile insurance for the cloud server 111 (personal information saving unit 613) in advance. Once the information is registered, however, the viewer can see the estimated cost each time the television CM for the automobile insurance is shown.

Here, the cloud server 111 that manages personal information and the service provider 120 operated by the automobile insurance business owner are desirably separated from each other as illustrated in FIG. 3. This is because, in this configuration, if an automobile insurance company other than the ABC General Insurance 701 is in partnership with the cloud server 111 (data center operating company 110), the registered information 704 (personal information) necessary to estimate the cost of the automobile insurance can be used, thereby making it possible to display an estimated insurance cost.

That is, once a viewer registers the information to the cloud server 111, the viewer can obtain estimated costs of various types of automobile insurance of companies shown in CMs just by watching television. This is a significant advantage to viewers. In addition, automobile insurance companies such as the ABC General Insurance 701 need not manage personal information regarding persons who are not yet their customers but just need estimates, which is advantageous.

In this configuration, it is only required that automobile insurance companies such as the ABC General Insurance 701 pay the data center operating company 110 that operates the cloud server 111 a personal information use fee according to the number of times that personalized information is generated and displayed as a cost of using personal information (information 704). Therefore, those who operate the cloud server 111 can receive the personal information use fee, which is advantageous.

It is to be noted that the configuration illustrated in FIG. 3 is an example, and the configuration of the advertisement data providing system 1000 is not limited to that illustrated in FIG. 3. For example, the estimated insurance cost may be calculated by the data center operating company 110 that operates the cloud server 111 at the request of the ABC General Insurance 701. The service provider 120 operated by the ABC General Insurance 701 may manage personal information.

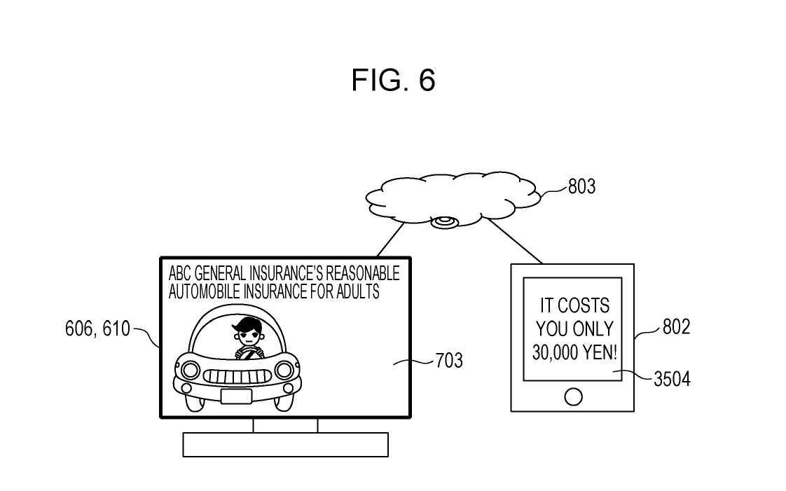

In addition, a mode of displaying a CM video upon which personalized information is superimposed is not limited to that illustrated in FIG. 3. FIG. 6 is a diagram illustrating another mode of displaying a CM video upon which personalized information is superimposed.

In the display mode illustrated in FIG. 6, the television CM video 703 transmitted from the video transmission unit 601 is displayed on the display section 610 of the video playback unit 606 (television). On the other hand, a video based on the HTML file 3504 (personalized information) is displayed on a display unit of a tablet terminal 802 connected to the video playback unit 606 and the Internet 803.

This display mode is effective compared to the display mode described with reference to FIG. 3 in that if a viewer who is interested in the personalized information desires to access more detailed information, the viewer can access the detailed information just by touching the tablet terminal 802. Thus, the tablet terminal 802 is superior to the television (video playback unit 606) in a user interface (UI). Therefore, if it is desired that a viewer be prompted to take action after the viewer checks personalized information, it is better to display a video based on the personalized information on the tablet terminal 802.

Alternatively, the advertiser (ABC General Insurance 701) may arbitrarily select one of a plurality of display modes in accordance with the situation. For example, a display mode may be specified using an HTML file generated by the personalized information generation unit 611, or the advertisement ID 615 included in the metadata 603 may include a display position specifier and the advertisement ID 615 may specify a display mode.

### Example when Advertiser is Automobile Manufacturer

Although display of an estimated cost of automobile insurance has been described as an example of the method for providing advertisement data, the method for providing advertisement data according to the first embodiment can be applied to another advertisement. FIGS. 7A to 7C are diagrams illustrating an example in which an estimated cost of purchasing an automobile is superimposed upon a television CM video for the automobile. FIGS. 8A and 8B are diagrams illustrating an example of information included in the advertisement information 612 in this case.

A viewer registers in advance information 902 regarding an automobile currently owned thereby to the personal information saving unit 613 (FIG. 7B). It is to be noted that in a configuration in which the automobile owned by the viewer is connected to a network and the current state of the automobile is automatically uploaded to the personal information saving unit 613, the information 902 regarding the automobile owned by the viewer is registered (saved) to the personal information saving unit 613 even if the viewer does not perform any operation.

With the information 902 saved in the personal information saving unit 613, an automobile manufacturer, which is an advertiser, places a television CM video 901 of an automobile called King (the name of a model of an automobile), which is a high-end automobile. As a result of the same configuration as that illustrated in FIG. 3, the viewer watches a television CM video 903 (FIG. 7C) through the video playback unit 606.

More specifically, first, the information 902, which is registered in the personal information saving unit 613, regarding the automobile owned by the viewer is read by the personalized information generation unit 611. The information 902 is evaluated by evaluation criteria 2501 included in the advertisement information 612 regarding King, and an estimated cost of a new King when the automobile owned by the viewer is traded in is calculated. As a result, the television CM video 903, in which the estimated cost (a video based on an HTML file 2504 illustrated in FIG. 8B) of purchasing a King is superimposed upon the television CM video 901 (FIG. 7A) is displayed.

In this case, the advertisement information 612 includes the evaluation criteria 2501, a calculation expression 2502, an HTML file 2503, and the like as illustrated in FIGS. 8A and 8B.

In the evaluation criteria 2501, parameters for calculating a trade-in price are defined. In the example of the evaluation criteria 2501, a base trade-in price is determined in accordance with the make of the automobile owned by the viewer, and ratios for increasing or decreasing the base trade-in price are determined in accordance with personal information such as a travel distance, whether the automobile has had an accident, and presence or absence of scratches.

A price obtained by subtracting the trade-in price determined in this manner from a base price of the automobile advertised in the CM is a purchase price for the viewer. That is, the purchase price is calculated on the basis of the calculation expression 2502. The calculated purchase price is displayed at a position of (A) in the HTML file 2503, which defines a basic display layout, and an HTML file 2504 is generated.

A CM video for a high-end automobile looks extremely attractive to viewers, but just because it is attractive, the high-end automobile undesirably strikes the viewers as a completely out-of-reach, lofty dream. Therefore, if the purchase price that takes into consideration the trade-in price of the automobile owned by the viewer is displayed as in the television CM video 903, the viewer might think that he/she can afford the automobile and begin to take specific purchase action.

Thus, the method for providing advertisement data according to the first embodiment is superior to common television CMs in leading viewers to take purchase action.

Next, an example in which the performance of an automobile to be advertised is superimposed upon a television CM video for the automobile will be described. FIGS. 9A to 9C are diagrams illustrating an example in which a maximum travel distance of the automobile is superimposed upon the television CM video for the automobile. FIGS. 10A and 10B are diagrams illustrating an example of information included in the advertisement information 612 in this case.

In FIGS. 9A to 9C, a television CM video 1001 (FIG. 9A) of an automobile called Queen (the name of a mode of an automobile), which is a hybrid vehicle, is illustrated as an example. As in the case illustrated in FIGS. 7A to 7C, a viewer registers in advance a make 1002 (model number) of a current automobile owned by the viewer to the personal information saving unit 613 (FIG. 9B). It is to be noted that if an automobile owned by the viewer is connected to a network, the make of the automobile may be directly registered from the automobile through the network.

With the make 1002 of the automobile owned by the viewer registered, the viewer watches a television CM video 1003 (FIG. 9C) as a result of the same configuration as that illustrated in FIG. 3.

More specifically, first, the make 1002 of the automobile, which is registered in the personal information saving unit 613, owned by the viewer is read by the personalized information generation unit 611. The make 1002 of the automobile is evaluated on the basis of an evaluation criterion 2601 included in the advertisement information 612 regarding Queen, and the fuel efficiency of the automobile owned by the viewer is calculated. It is to be noted that the fuel efficiency may be calculated on the basis of fuel efficiency information determined from the make 1002 while taking into consideration effects of the travel distance of the automobile, changes in the automobile over the years, and the like. The fuel efficiency calculated in this manner and the fuel efficiency of a new Queen are compared with each other, and information indicating how much the fuel efficiency of Queen is superior is calculated.

As a result, the television CM video 1003 in which the information indicating the calculated information (a video based on an HTML file 2604 illustrated in FIG. 10B) indicating the superiority in fuel efficiency is superimposed upon the television CM video 1001 is displayed.

In this case, as illustrated in FIGS. 10A and 10B, the advertisement information 612 includes the evaluation criterion 2601, a calculation expression 2602, an HTML file 2603, and the like.

In the evaluation criterion 2601, parameters for calculating the maximum travel distance of the automobile owned by the viewer are defined. In the example illustrated in FIGS. 10A and 10B, the maximum travel distance of the automobile owned by the viewer is determined on the basis of the make 1002 of the automobile owned by the viewer. A travel distance improvement estimate is obtained by subtracting the maximum travel distance determined in this manner from the maximum travel distance of the automobile advertised in the CM. That is, the travel distance improvement estimate is calculated on the basis of the calculation expression 2602. The HTML file 2604 in which the calculated value is displayed at a position of (A) of the HTML file 2603, which defines a basic display layout, is then generated.

A selling point of hybrid vehicles is their high fuel efficiency. However, a mere value indicating how much the fuel efficiency improves might not impress the viewer. Therefore, if the improvement is specifically described, like “You can drive 98 km further than now”, in comparison with the automobile currently owned by the viewer, the viewer can understand an advantage of Queen more deeply.

Next, an example in which a video for an automobile according to the preferences of a viewer is superimposed upon a television CM video for automobiles will be described. FIGS. 11A to 11C are diagrams illustrating an example in which a video for an automobile according to the preferences of a viewer is superimposed upon a television CM video for automobiles.

In FIGS. 11A to 11C, a television CM video 1101 (FIG. 11A) that introduces a new vehicle line of an automobile manufacturer is illustrated as an example. Here, the personal information saving unit 613 stores a lifelog 1102 of the viewer (FIG. 11B).

The lifelog 1102 is information uploaded by home appliances owned by the viewer and connected to a network. More specifically, the lifelog 1102 includes information regarding model numbers, how long the home appliances have been used, periods in which the viewer typically uses the home appliances, and the like. For example, if the home appliances include a microwave, information indicating when and how the viewer cooked is uploaded as the lifelog 1102. If the home appliances include a television or a recorder, information indicating what kind of program the viewer watched or recorded is uploaded as the lifelog 1102. In addition, in the personal information saving unit 613, age and gender input by the viewer as responses to an interview conducted when the viewer began to use a VOD service of television, a purchase history indicating what kind of VOD service the viewer has used, and the like are saved as the lifelog 1102.

With the lifelog 1102 of the viewer registered, the viewer watches a television CM video 1103 (FIG. 11C) showing a vehicle line as a result of the same configuration as that illustrated in FIG. 3.

More specifically, first, the lifelog 1102 of the viewer registered in the personal information saving unit 613 is read by the personalized information generation unit 611. Tastes and preferences of the viewer are analyzed on the basis of the lifelog 1102. One of a plurality of information categories included in the advertisement information 612, that is, one of new automobiles in the vehicle line, is selected on the basis of a result of the analysis, and the television CM video 1103 upon which the selected automobile in the vehicle line is superimposed is displayed.

The tastes and preferences of the viewer can be extracted from the lifelog 1102 using various methods. For example, if the lifelog 1102 includes a model number of a home appliance, a kind of color that the viewer likes can be extracted on the basis of the color of the home appliance identified from the model number. Whether the color of the home appliance is white or beige, gray or black, or red or yellow closely reflects the tastes of the viewer. For example, if home appliances owned by the viewer are all black, it is preferable to select a black automobile as an automobile to be recommended.

In addition, the unit price of each home appliance is also importance information. The economic state of a viewer can be inferred to some extent on the basis of whether each home appliance is a high-end product, a product in a popular price range, or a low-end product. If a viewer owns low-end home appliances, it is likely that a small automobile better suits the preferences of the viewer than a high-end automobile. Even if a viewer owns low-end home appliances, however, a sports car, not a small automobile, should be recommended if a television viewing history of the viewer indicates that the viewer often watches automobile programs or if a video of automobile racing has been purchased through VOD.

In addition, whether the viewer lives with his/her family or alone can be inferred from a history of using home appliances. As a result of the inference, whether to recommend a station wagon for families can be determined. In addition, an automobile to be recommended may be selected in accordance with the gender or age of the viewer.

Such extraction of tastes and preferences is, for example, performed for each viewer while weighting each parameter. In addition, lifelogs 1102 of a plurality of viewers may be statistically processed, and tastes and preferences may be extracted using a result indicating, for example, “viewers who own this kind of home appliance are likely to own this kind of automobile”.

A specific example of a method for extracting tastes and preferences will be described with reference to FIGS. 12A and 12B. FIGS. 12A and 12B are diagrams illustrating a specific example of the method for extracting tastes and preferences.

In the example illustrated in FIGS. 12A and 12B, tastes and preferences are expressed in a two-dimensional space 2702 defined by two axes, namely a first axis representing high-end (luxury) or low-end (popular price range) and a second axis representing formal or casual.

In the two-dimensional space 2702 defined in this manner, dots representing automobiles such as King, Queen, and Jack are plotted in advance (white circles illustrated in FIG. 12B). For example, Jack (the name of a model of an automobile), which is a casual model and in the popular price range, is plotted in a lower-left quadrant of the two-dimensional space 2702.

On the other hand, in information 2701 (FIG. 12A) included in the advertisement information 612, model numbers of home appliances and a viewing history are associated with coordinates in the two-dimensional space 2702 and stored. The personalized information generation unit 611 refers to the information 2701, obtains the coordinates of home appliances owned by a viewer, and plots the home appliances in the two-dimensional space 2702 as dots indicating personal information (black circles illustrated in FIG. 12B).

The sum of distances between each dot (white circle) indicating an automobile and the dots (black circles) indicating the personal information is calculated. An automobile indicated by a white circle with which the sum of distances is the smallest is then selected as an automobile to be recommended (advertised) according to the tastes and preferences of the viewer.

The method for providing advertisement data in which the tastes and preferences of the viewer are extracted in this manner produces a significant effect of changing a television CM video indefinitely broadcast to the public into a video intended for each individual. In particular, a television CM video that introduces a plurality of products can be changed into a television CM video that focuses upon a single product that suits the preferences of each viewer.

### Example when Advertiser is Automobile Dealer

Next, an example in which a map is superimposed upon a television CM video for an automobile dealer will be described. FIGS. 13A to 13C are diagrams illustrating an example in which a map is superimposed upon a television CM video for an automobile dealer.

FIGS. 13A to 13C illustrate a television CM video 1201 (FIG. 13A) that introduces an automobile dealer as an example. Here, a postcode 1202 of a viewer is stored in the personal information saving unit 613 (FIG. 13B). As a result of the same configuration as that illustrated in FIG. 3, the viewer watches a television CM video 1203 (FIG. 13C) that introduces an automobile dealer.

More specifically, the postcode 1202 of the viewer registered in the personal information saving unit 613 is read by the personalized information generation unit 611, and a dealer nearest to the address (postcode) of the viewer is selected. A map including a route from the viewer's home to the nearest dealer is then generated, and the television CM video 1203 in which the map is superimposed upon the television CM video 1201 for the automobile dealer is displayed.

A specific example of the above-described method for generating a map will be described with reference to FIGS. 14A and 14B. FIGS. 14A and 14B are diagrams illustrating a specific example of the method for generating a map.

Information 2801 (FIG. 14A) is part of the advertisement information 612 in which first three digits of each postcode, the name of a dealer nearest to an address indicated by each postcode, and the address of each dealer are associated with one another. As indicated in a block diagram 2802 (FIG. 14B), the personalized information generation unit 611 obtains the address of the nearest dealer associated with the postcode 1202 using the information 2801 included in the advertisement information 612 and accesses an external map service provider 2803 using the obtained address as an argument. The personalized information generation unit 611 then obtains map data regarding an area around the nearest dealer from the map service provider 2803 and generates an HTML file of a video to be superimposed upon the television CM video 1201 on the basis of the obtained map data.

Few viewers try to locate and visit a dealer even after watching a television CM video that introduces the dealer. However, if a dealer near to a viewer's home is selected and a map to the selected dealer is displayed, the viewer can be lead to take consumption action.

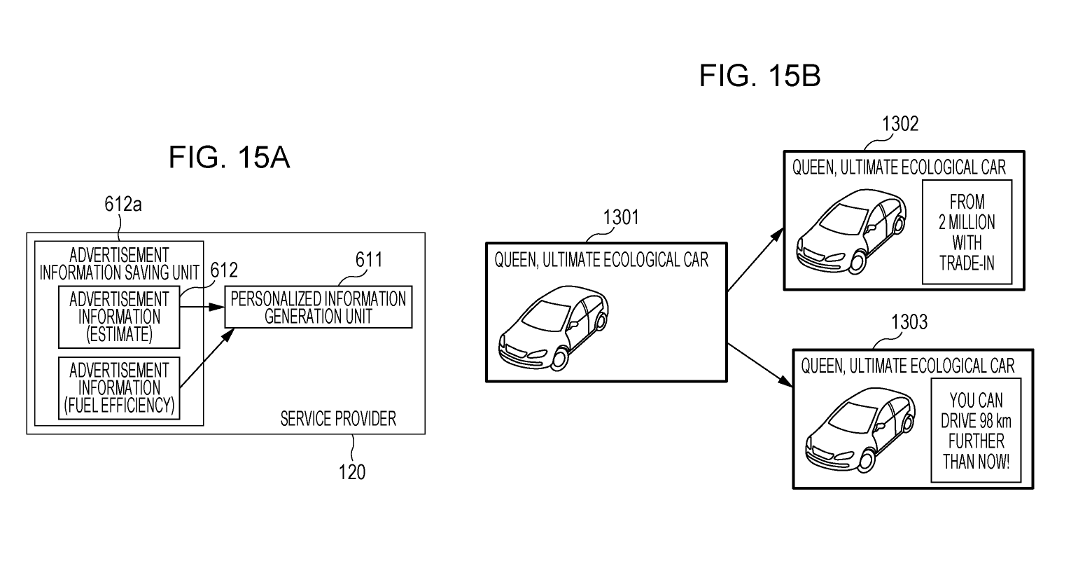

A specific example of the method for providing advertisement data has been described above on the basis of the first embodiment. Although a piece of personalized information is generated for one television CM video in the first embodiment, the method for providing advertisement data according to the first embodiment is not limited to this aspect. FIGS. 15A and 15B are diagrams illustrating an example in which two or more pieces of personalized information are generated for one television CM video.

As illustrated in FIG. 15A, in the service provider 120, the personalized information generation unit 611 generates, for example, two types of personalized information using advertisement information 612 regarding an estimated purchase cost and advertisement information 612 regarding fuel efficiency.

As a result, as illustrated in FIG. 15B, the two types of personalized information are superimposed upon a television CM video 1301. More specifically, a television CM video 1302 upon which the estimated cost is superimposed and a television CM video 1303 upon which a maximum travel distance (fuel efficiency) is superimposed are selectively displayed.

The selection of the personalized information is performed, for example, in accordance with the tastes and preferences of the viewer based on the lifelog 1102 described with reference to FIGS. 11A to 11C. More specifically, if home appliances owned by the viewer include many home appliances that are expensive but have various ecological functions, it is likely that the viewer is interested in ecological functions rather than the purchase cost of a new automobile. Therefore, the television CM video 1303 upon which personalized information regarding the fuel efficiency is superimposed is selected.

Alternatively, the personalized information may be selected on the basis of a display history. For example, if the service provider 120 saves a display history indicating what kind of personalized information has been displayed for a viewer identified by a personal ID, a type of personalized information different from a type of personalized information displayed previously can be selected. That is, a process can be realized in which because the television CM video 1303 was displayed previously, the television CM video 1302 is displayed this time.

In addition, in the first embodiment, information necessary to generate personalized information is all saved in the personal information saving unit 613. However, it is possible that personalized information cannot be generated because information is not registered in the personal information saving unit 613.

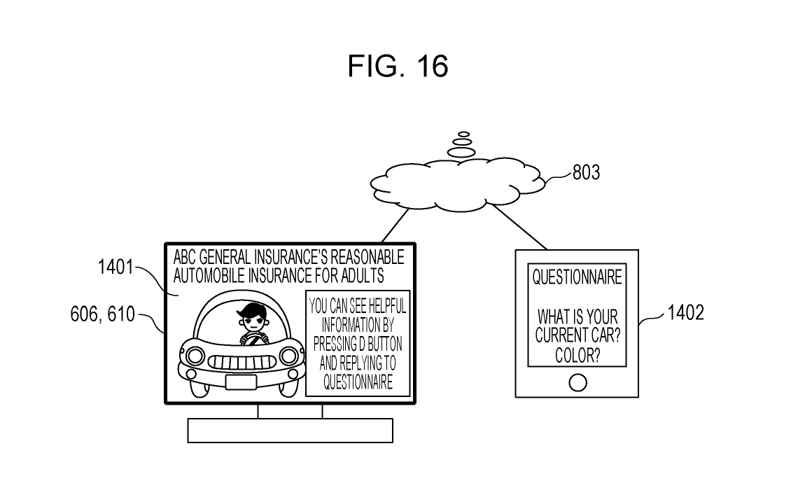

In this case, a television CM video upon which no personalized information is superimposed (that is, a blank is superimposed) may be displayed as described in step S2407 illustrated in FIG. 4, but a message asking a viewer to register personal information may be superimposed as illustrated in FIG. 16. FIG. 16 is a diagram illustrating an example in which a message asking a viewer to register personal information is superimposed.

As in a television CM video 1401 illustrated in FIG. 16, a message notifying a viewer that personalized information is displayed if the viewer replies to a questionnaire may be generated and displayed, in order to prompt the viewer to register necessary personal information. In this case, it is more preferable that a tablet terminal 1402 (connected to the video playback unit 606 through the Internet 803) display a form for filling in the questionnaire.

In addition, the television CM videos described in the above embodiment are examples, and the method for providing advertisement data according to the first embodiment can be applied to various other television CM videos.

For example, the method for providing advertisement data can be applied to a television CM video for a wedding center. If a viewer registers the number of people to be invited to the viewer's wedding ceremony and the grade of the wedding ceremony, a rough estimate of the cost of the wedding ceremony can be displayed. In addition, the method for providing advertisement data according to the first embodiment can be applied to a television CM video for house renovation. In this case, if the size and age of the viewer's house or the like are registered, a rough estimate of the cost can be displayed.

In addition, in the method for providing advertisement data, if a television CM video for women's clothing is shown but the viewer is male, a television CM video upon which personalized information indicating, for example, “this is the greatest present for her” is superimposed can be displayed. In the method for providing advertisement data, if the viewer's weight is registered, a recommended dish (for example, a diet dish) according to the viewer's weight can be displayed in a television CM video for a restaurant.

### Effects

Thus, according to the method for providing advertisement data according to the first embodiment, even with a television CM video that is not effective to a particular viewer, an advertising effect can be improved by superimposing personalized information. That is, a CM placement cost can be less wasted.

It is to be noted that the personalized information in the first embodiment is assumed to be a still image, the personalized information may be a moving image, instead. In addition, the personalized information need not be superimposed upon part of a television CM, but the entirety of a screen may change.

In addition, although an example in which personalized information is superimposed upon a television CM video has been described in the first embodiment, personalized information may be superimposed upon a scene in a television program such as a drama or news. In the method for providing advertisement data according to the first embodiment, for example, if news about a share price movement of a certain company is being broadcast in a news program and the viewer owns the company's shares, how much the assets of the viewer have changed can be displayed.

### Second Embodiment

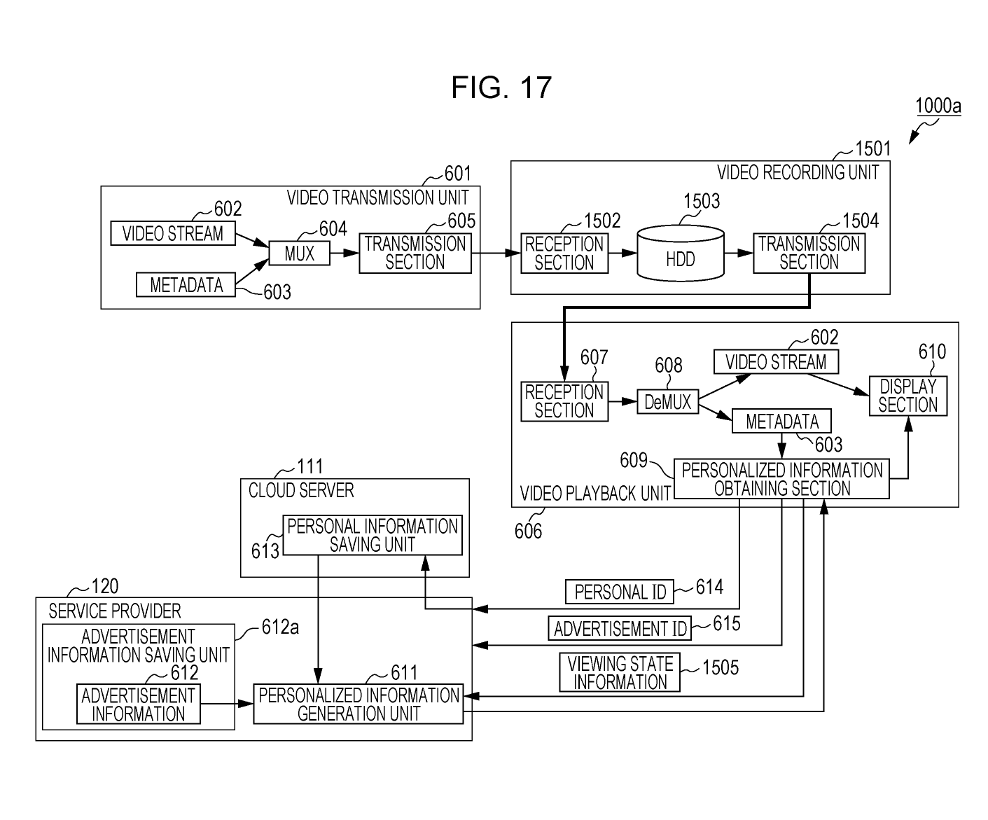

A detailed configuration of an advertisement data providing system according to a second embodiment will be described hereinafter. FIG. 17 is a diagram illustrating the detailed configuration of the advertisement data providing system according to the second embodiment. It is to be noted that in FIG. 17, description of components that have already been described in the first embodiment is omitted.

An advertisement data providing system 1000a according to the second embodiment is different from the advertisement data providing system 1000 in that the advertisement data providing system 1000a includes a video recording unit 1501.

The video recording unit 1501 includes a reception section 1502, an HDD 1503, and a transmission section 1504. The video recording unit 1501 receives a video stream transmitted from the video transmission unit 601 using the reception section 1502 and accumulates (saves) the video stream in the HDD 1503. That is, the video recording unit 1501 corresponds to a device such as a digital versatile disc (DVD) recorder or a Blu-ray Disc (BD; registered trademark) recorder. That is, as a result of an operation performed by a viewer, a video stream is read from the HDD 1503 of the video recording unit 1501 and played back by the video playback unit 606.

The video playback unit 606 is, for example, a television installed in a house, but may be a tablet terminal that can be used outside the house, instead. If the video playback unit 606 is a tablet terminal, the video playback unit 606 is connected to the video recording unit 1501 through the Internet or the like, and a video stream is transmitted to the video playback unit 606.

In addition, the advertisement data providing system 1000a is different from the advertisement data providing system 1000 in that the personalized information obtaining section 609 transmits viewing state information 1505 to the personalized information generation unit 611.

The viewing state information 1505 is information indicating a place and a time at which the video playback unit 606 plays back a video. If the video playback unit 606 is a tablet terminal, the viewer might watch an accumulated video outside the viewer's home. In this case, the personalized information obtaining section 609 obtains positional information while the viewer is watching the video using a Global Positioning System (GPS) or the like and transmits the positional information to the service provider 120 (personalized information generation unit 611) as the viewing state information 1505 along with the personal ID 614 and the advertisement ID 615, which have already been described.

In the second embodiment, a television CM video to be watched is accumulated in the video recording unit 1501. Therefore, a period in which the television CM video is broadcast and a period in which the viewer watches the television CM video are different from each other.

Most of television CM videos have their effective periods as advertisements, and after these periods, their effects as advertisements are lost. An object of the second embodiment is to improve the advertising effect of a television CM video that is no longer effective (whose effective period has ended) using personal information (that is, the viewing state information 1505) indicating “a period in which the viewer is watching”.

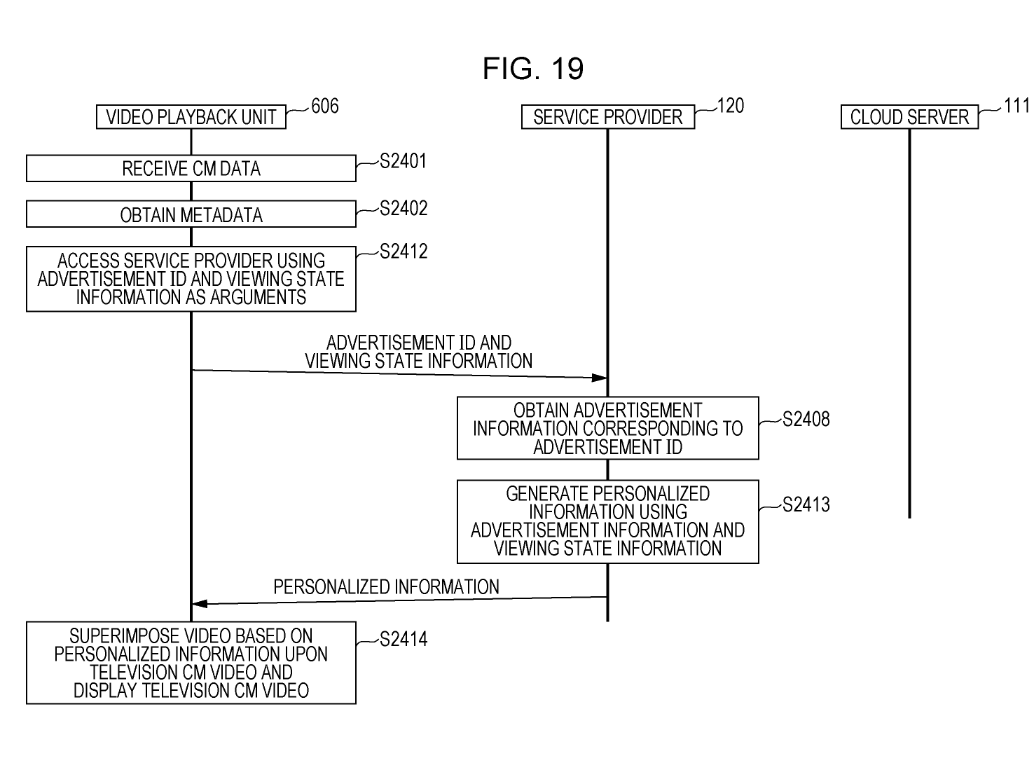

A television CM video displayed in a method for providing advertisement data according to the second embodiment will be described hereinafter. FIGS. 18A and 18B are diagrams illustrating an example of a television CM video according to the second embodiment. FIG. 19 is a sequence diagram of the method for providing advertisement data used by the advertisement data providing system 1000a. It is to be noted that in FIG. 19, steps that have already been described with reference to FIG. 4 are given the same reference numerals, and description thereof is omitted.

As illustrated in FIGS. 18A and 18B, a television CM video 1601 is a television CM video for an automobile dealer. The television CM video 1601 advertises that if a viewer participates in a test-drive event held by the dealer by July 15, the viewer is given a watermelon.

Here, it is assumed that the viewer watches the television CM video 1601 recorded in the video recording unit 1501 in August. This means that the television CM video 1601 has expired (whether a television CM video has expired can be determined by identifying the television CM video using an advertisement ID transmitted to the service provider 120).

In this case, in the method for providing advertisement data according to the second embodiment, a process illustrated in FIG. 19 is performed. In the method for providing advertisement data according to the second embodiment, the personalized information obtaining section 609 of the video playback unit 606 accesses the service provider 120 using the advertisement ID and the viewing state information 1505 as arguments (S2412). That is, the advertisement ID and the viewing state information 1505 are transmitted from the video playback unit 606.

The service provider 120 obtains the advertisement information 612 corresponding to the advertisement ID (S2408) and generates personalized information using the advertisement information 612 and the viewing state information 1505 (S2413). Here, the personalized information is information (for example, an HTML file) indicating that the viewer is given somen noodle in a test-drive event in August. As a result, a television CM video 1602 upon which such information is superimposed is displayed.

Thus, according to the method for providing advertisement data according to the second embodiment, a television CM video that has expired due to a difference between a broadcast period and a viewing period can be revived as an effective television CM video.

It is to be noted that although the video recording unit 1501 indicating a viewing time is transmitted from the video playback unit 606 in FIG. 19, this configuration need not be used insofar as the service provider 120 can identify the viewing time of the viewer.

Next, another example of the television CM video according to the second embodiment will be described. FIGS. 20A and 20B are diagrams illustrating an example in which a map is superimposed upon a television CM video.

In the example illustrated in FIGS. 20A and 20B, the personalized information generation unit 611 generates personalized information using not only the viewing state information 1505 but also the position of the viewer included in the personal information saving unit 613 described with reference to FIGS. 13A to 13C. In the example illustrated in FIGS. 20A and 20B, however, not the postcode but positional information obtained by a tablet terminal that is being used outside the viewer's home is used. It is to be noted that the positional information is transmitted to the service provider 120 as the viewing state information 1505.

As a result, a nearest dealer is selected from positional information regarding a current location, and a map indicating a route from the current location to the dealer is displayed. Furthermore, since the television CM video 1601 has expired now, information indicating that the viewer is given somen noodle, not a watermelon, is added to a television CM video 1701 on the basis of the viewing state information 1505.

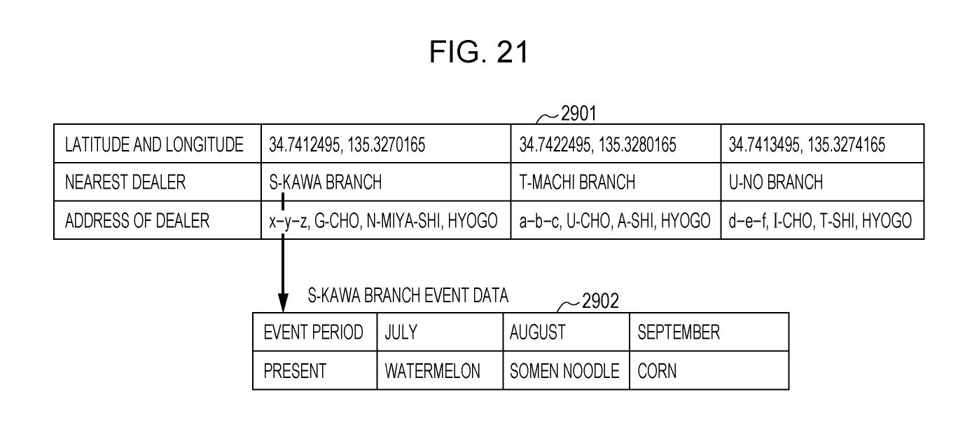

A specific method for displaying the television CM video illustrated in FIGS. 20A and 20B will be described with reference to FIG. 21. FIG. 21 is a diagram illustrating a method for generating personalized information using the viewing state information 1505 and positional information.

Information 2901 illustrated in FIG. 21 is part of the advertisement information 612. In the information 2901, the name and address of each dealer and the position (latitude and longitude) of each dealer are associated with each other. The personalized information generation unit 611 selects, using the information 2901, a dealer whose latitude and longitude are nearest to positional information (latitude and longitude) obtained using a GPS function of the tablet terminal.

The personalized information generation unit 611 then reads event data 2902 regarding the selected dealer. The event data 2902 is part of the advertisement information 612. In the event data 2902, each event period and a product presented in each event are associated with each other.

Thus, according to the personalized information using the viewing state information 1505 and the positional information, the viewer can see a map to the nearest dealer and the content of an event that is currently held even outside the viewer's home.

Next, yet another example of the television CM video according to the second embodiment will be described. FIGS. 22A and 22B are diagrams illustrating another example of the television CM video according to the second embodiment.

In the example illustrated in FIGS. 22A and 22B, the personalized information generation unit 611 generates personalized information on the basis of not only the viewing state information 1505 but also extracted tastes and preferences based on the lifelog 1102 saved in the personal information saving unit 613. That is, as indicated by a television CM video 1801, it is determined on the basis of the lifelog 1102 that the viewer is likely to be interested in the automobile called Jack, and the automobile is recommended. In the television CM video 1801, information indicating that the viewer is now given somen noodle, not a watermelon, is also added.

As described above, according to the method for providing advertisement data according to the second embodiment, the advertising effect of a television CM video that is stored in the video recording unit 1501 and whose broadcast period and viewing period are different from each other can be revived. In addition, if the video playback unit 606 is a tablet terminal or the like, personalized information according to the current location of the viewer can be generated using GPS information.

### Third Embodiment

In the first and second embodiments, personalized information is all information relating to a product sold by an advertiser (or a store managed by an advertiser). In a third embodiment, a mode in which personalized information relates to a product sold by a business owner who is different from an advertiser of a television CM video will be described.

A detailed configuration of an advertisement data providing system according to the third embodiment will be described hereinafter. FIG. 23 is a diagram illustrating the detailed configuration of the advertisement data providing system according to the third embodiment. It is to be noted that in FIG. 23, description of components that have already been described in the first embodiment is omitted.

An advertisement data providing system 1000b according to the third embodiment is different from the advertisement data providing system 1000 in terms of the configurations of a service provider A 1901, a service provider C 1902, a service provider D 1903, and a service provider E 1904.

The service provider A 1901 (server of the service provider A 1901) is operated by a business owner who has placed a television CM, and generates personalized information to be superimposed upon the television CM. It is to be noted that the service provider A 1901 is an example of the advertisement data generation system.

The service provider C 1902, the service provider D 1903, and the service provider E 1904 are operated by business owners different from the business owner who operates the service provider A 1901, and hold the advertisement information 612 regarding products sold by the business owners.

The service provider A 1901 is different from the service provider 120 in that the service provider A 1901 includes an alternative information selection unit 1905 and an alternative information generation unit 1906.

The alternative information selection unit 1905 exists in the service provider A 1901 and selects the advertisement information 612. Here, the advertisement information 612 is selected from among the pieces of the advertisement information 612 registered to the service provider C 1902, the service provider D 1903, and the service provider E 1904 in advance.

The alternative information generation unit 1906 generates personalized information on the basis of the advertisement information selected by the alternative information selection unit 1905.

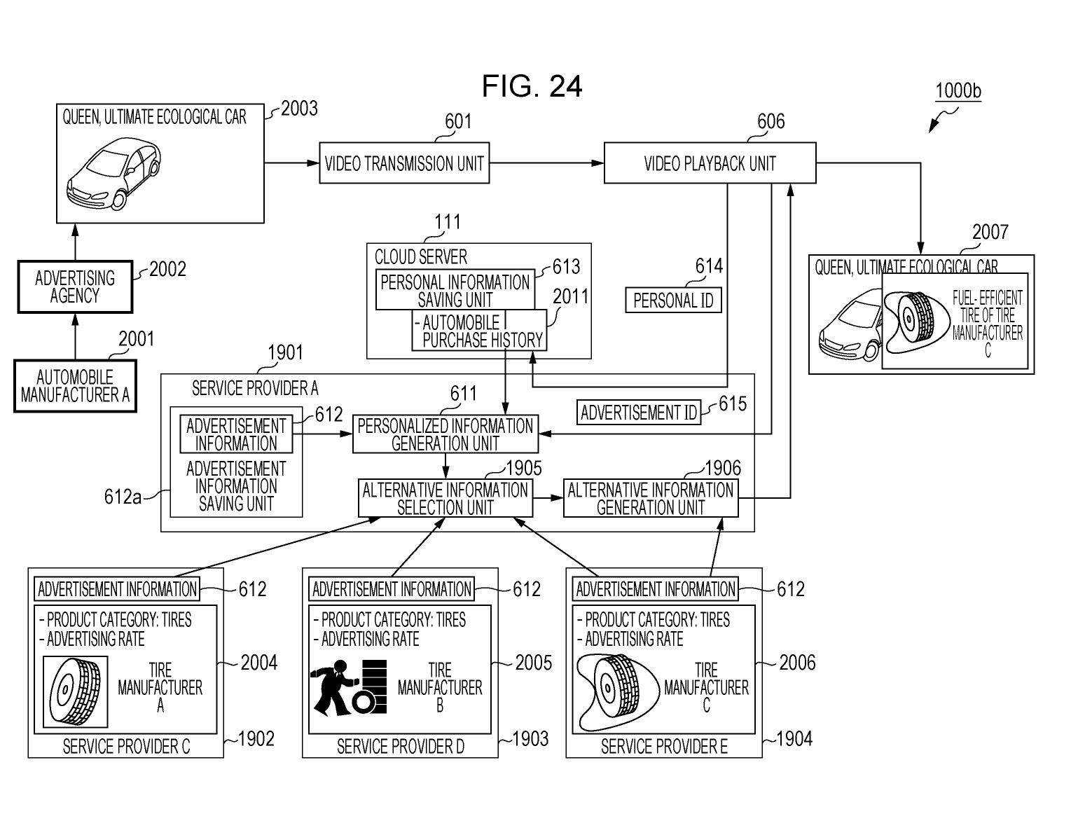

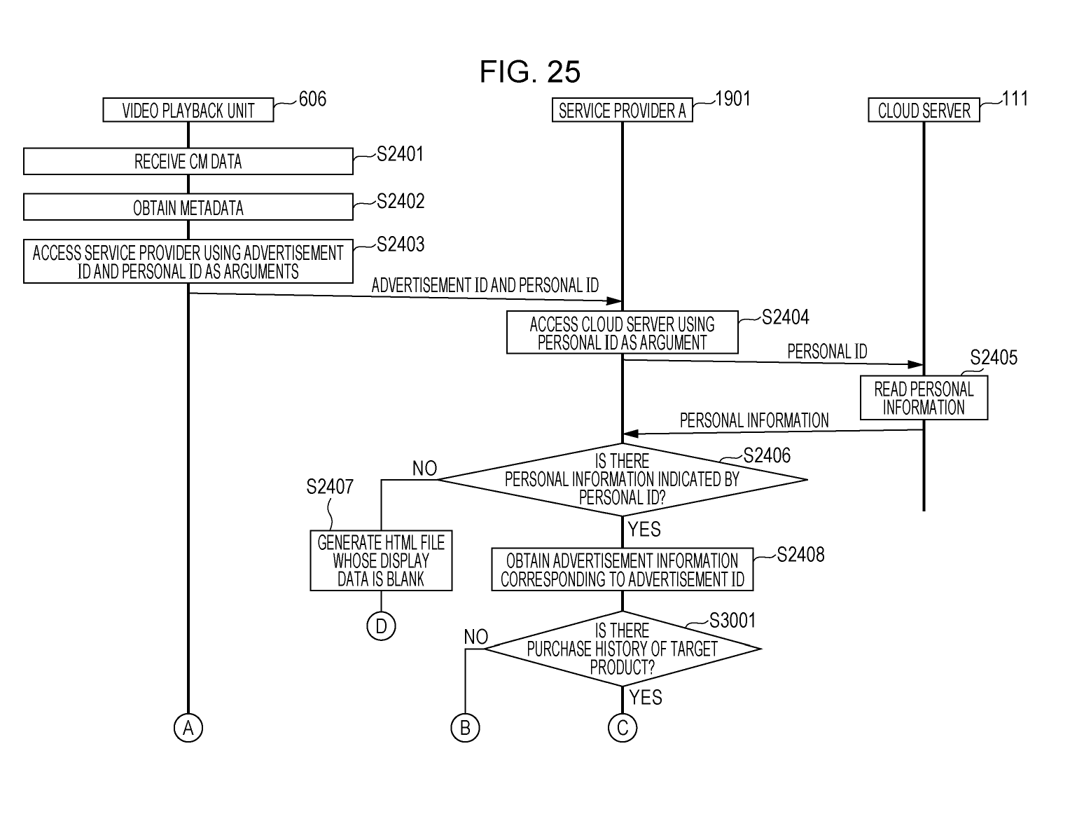

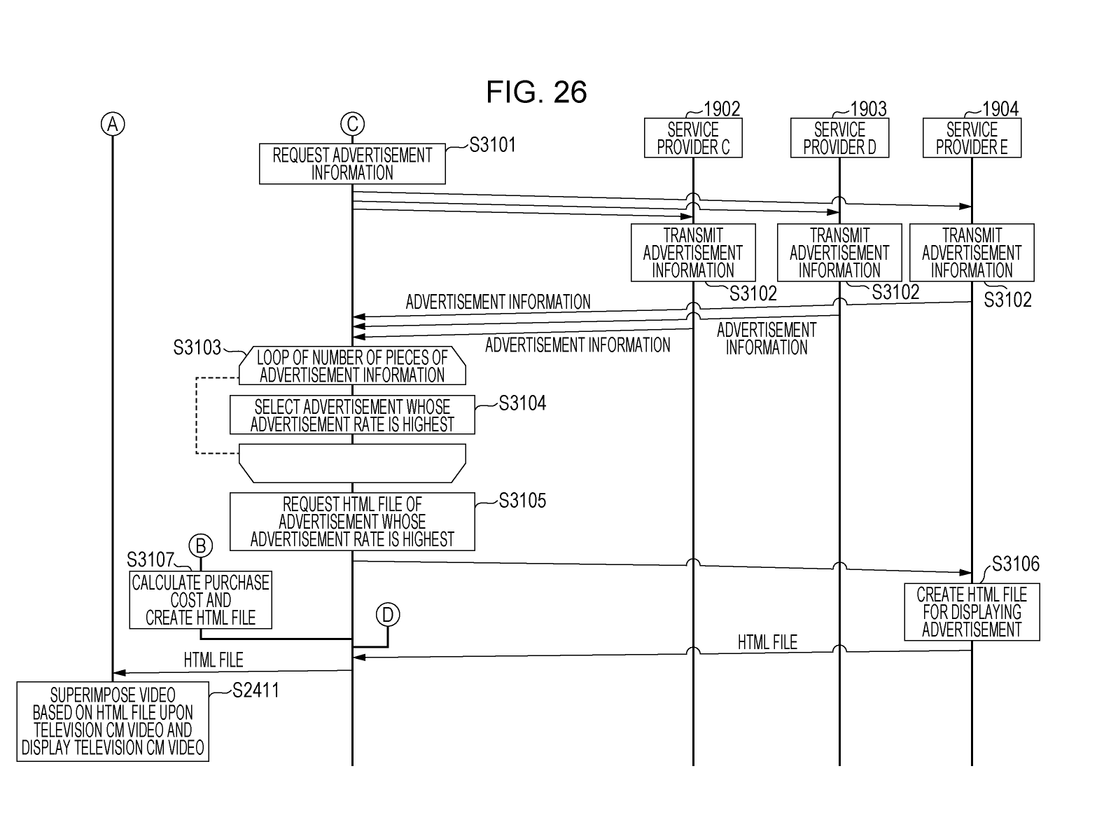

A method for providing advertisement data used by the advertisement data providing system configured in the above manner will be specifically described. FIG. 24 is a diagram illustrating an example of a television CM video according to the third embodiment. FIGS. 25 and 26 are sequence diagrams of the method for providing advertisement data used by the advertisement data providing system 1000b. It is to be noted that in FIGS. 25 and 26, description of steps having the same reference numerals as those illustrated in FIG. 4 is omitted.

An automobile manufacturer A 2001 is a business owner who operates the service provider A 1901 and sells the automobile called Queen. The automobile manufacturer A 2001 requests a television station to place a television CM video 2003 through an advertising agency 2002.

If the viewer watches the television CM video 2003 for Queen, the personalized information generation unit 611 obtains personal information 2011 from the personal information saving unit 613 as in the first embodiment (S2408). The personalized information generation unit 611 then checks whether the personal information 2011 includes a purchase history indicating that the viewer has recently purchased a Queen (S3001). If the personal information 2011 does not include the purchase history (No in S3001), the personalized information generation unit 611 calculates a trade-in price of a Queen and generates an HTML file as in FIGS. 7A to 7C (S3107).

An operation performed when the personal information 2011 includes a purchase history indicating that the viewer has recently purchased a Queen (Yes in S3001) will be described.

The advertising effect of showing a television CM for Queen to a viewer who has recently purchased a Queen is almost zero. Therefore, the service provider A 1901 requests the registered advertisement information 612 from the service provider C 1902, the service provider D 1903, and the service provider E 1904 operated by the other business owners (S3101). Each service provider transmits the advertisement information 612 (S3102), and the alternative information selection unit 1905 (service provider A 1901) obtains the three pieces of advertisement information 612 (more specifically, advertisement information 2004, advertisement information 2005, and advertisement information 2006) that have been transmitted.

Next, the alternative information selection unit 1905 checks advertising rates included in the three pieces of advertisement information 612 and selects advertisement information 612 including a highest advertising rate (S3103 and S3104). In the example illustrated in FIG. 26, the alternative information selection unit 1905 selects the service provider E 1904 (the advertisement information 612 from the service provider E 1904) operated by a tire manufacturer C, which has offered the highest advertising rate.

Next, the alternative information generation unit 1906 requests an HTML file for displaying an advertisement from the service provider E 1904 (S3105). The service provider E 1904 creates the HTML file for displaying an advertisement (S3106). More specifically, the service provider E 1904 generates information regarding a fuel-efficient tire sold by the tire manufacturer C. It is to be noted that the process for creating an HTML file in step S3106 may be performed by the alternative information generation unit 1906 by receiving information for displaying an advertisement from the service provider E 1904, instead.

The video playback unit 606 receives the HTML file through the service provider A 1901 (alternative information generation unit 1906) and displays a television CM video 2007, in which a video based on the received HTML file is superimposed upon the television CM video 2003, on the display section 610 (S2411). Because the tire manufacturer C has displayed the advertisement thereof, the tire manufacturer C pays the automobile manufacturer A 2001 the advertising rate that the tire manufacturer C has offered.

A television CM video is, so to speak, broadcast by buying part of the time of television broadcasting. In addition, even if the television CM video is not effective, advertising cost is not returned.

On the other hand, according to the method for providing advertisement data according to the third embodiment, if it is determined on the basis of personal information that a television CM video is not effective, an advertisement of another business owner can be superimposed.

In the above example, if the automobile manufacturer A 2001 determines that a television CM video thereof is no longer effective to a certain viewer, the automobile manufacturer A 2001 can obtain money by selling the time of the television CM video to the tire manufacturer C. It is costly for the tire manufacturer C to buy the time of many television CMs. However, the tire manufacturer can buy, at a reasonable price, the time of the television CM video of the automobile manufacturer A 2001 that is no longer necessary.

It is to be noted that although a service provider is selected on the basis of the advertising rate in the third embodiment, a service provider may be selected in any manner. For example, a product of another company that can be used with (suits) the product advertised in a television CM video may be selected. More specifically, if the advertised product is an automobile having excellent fuel efficiency performance, an advertisement for a tire whose fuel efficiency effect is the highest may be selected.

Alternatively, for example, a service provider may be selected on the basis of personal information regarding a viewer. In addition, although a plurality of service providers (a plurality of business owners) in a product category of tires are selection options in the above example, the alternative information selection unit 1905 may initially select a product category (for example, a product category of tires, car air fresheners, car wax, or the like) and then select a service provider (business owner) that deals in the product.

Now, although the automobile manufacturer A 2001 manages placement of a CM of another company in the configuration described in the third embodiment, such a configuration means that the automobile manufacturer A 2001 performs operations like ones performed by an advertising agency, which might be unrealistic.

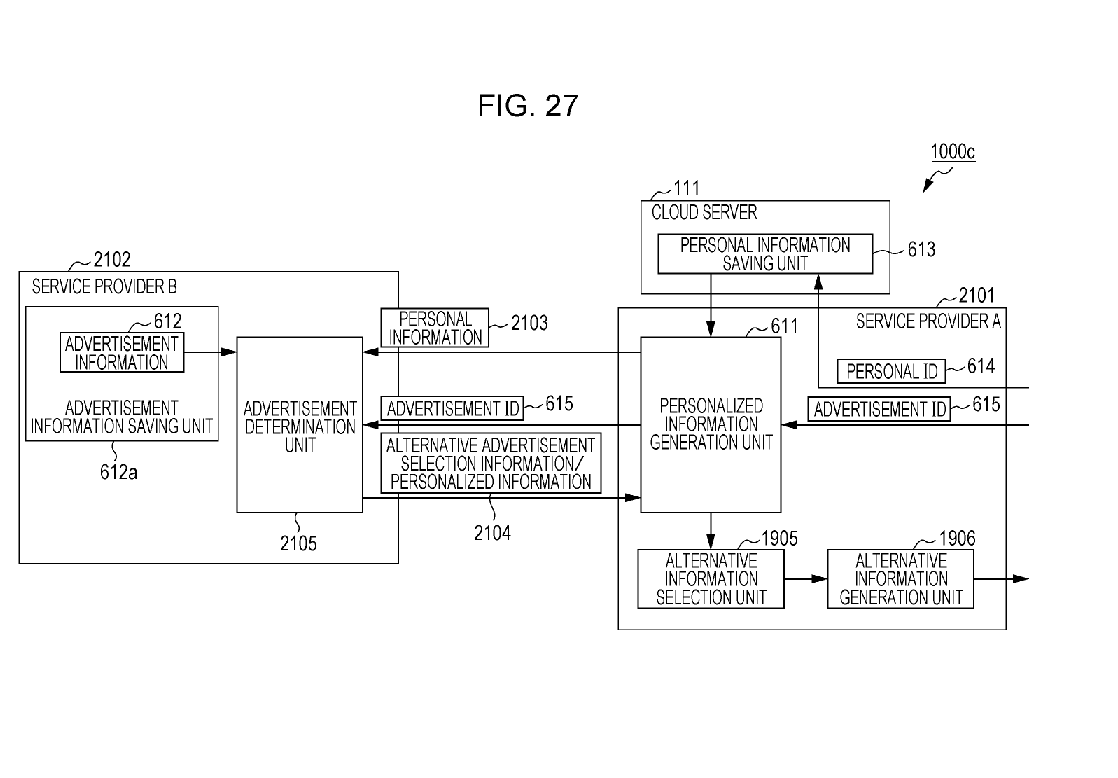

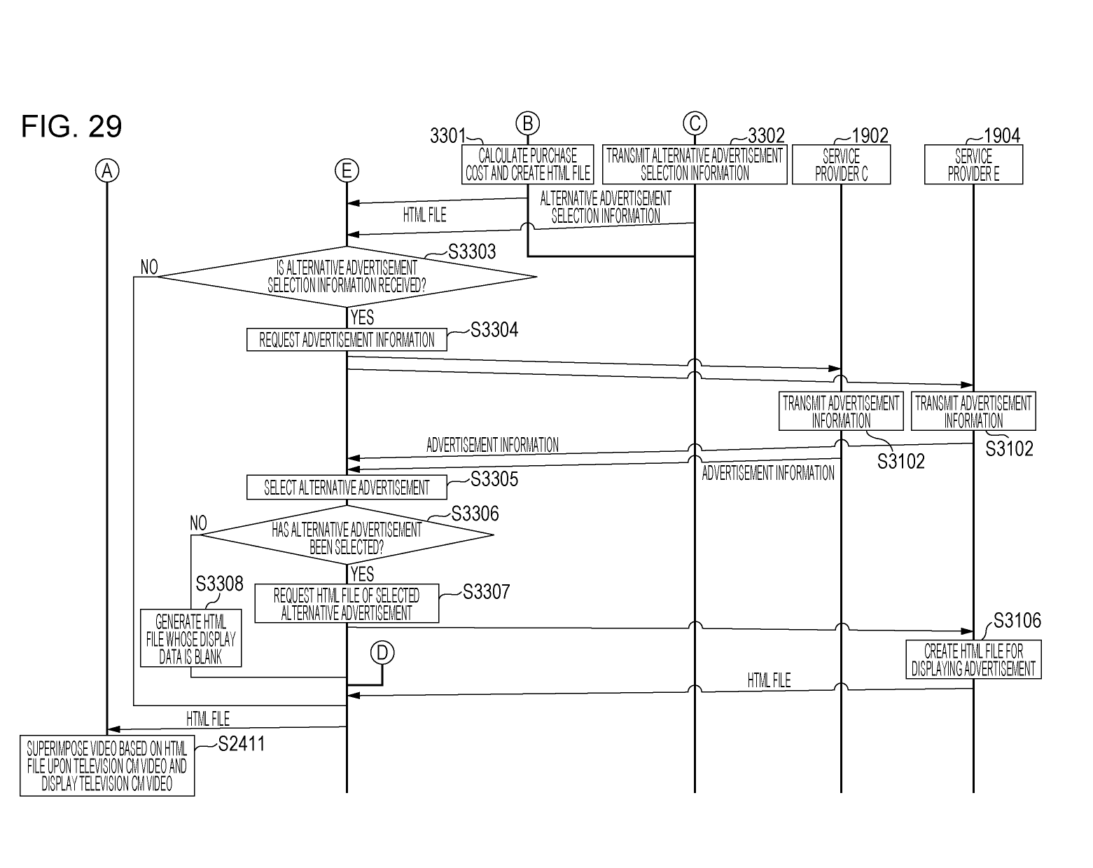

Therefore, a configuration will be described hereinafter in which a business owner who desires to place an advertisement and an advertising agency that handles placement of an advertisement for such a business owner are separated from each other. FIG. 27 is a diagram illustrating a detailed configuration of an advertisement data providing system in which a business owner and an advertising agency are separated from each other. FIGS. 28 and 29 are sequence diagrams of a method for providing advertisement data used by the advertisement data providing system illustrated in FIG. 27. It is to be noted that in FIG. 27, part of an advertisement data providing system 1000c is illustrated.

A service provider A 2101 illustrated in FIG. 27 is operated not by the automobile manufacturer A 2001 but by another business owner such as an advertising agency. The automobile manufacturer A 2001 operates a service provider B 2102. It is to be noted that the service provider A 2101 is an example of the advertisement data generation system.

If the television CM video 2003 for Queen is viewed, first, the service provider A 2101 is called by the personalized information obtaining section 609 (not illustrated in FIG. 27). The personalized information generation unit 611 of the service provider A 2101 then transmits, to the service provider B 2102 identified by the advertisement ID 615, personal information 2103 read from the personal information saving unit 613 along with the advertisement ID 615 (S3201).

The service provider B 2102 includes an advertisement determination unit 2105. The advertisement determination unit 2105 determines whether to superimpose personalized information of the automobile manufacturer A 2001 upon a television CM for the automobile manufacturer A 2001 or sell an advertising space to another business owner. That is, as in step S3001 illustrated in FIG. 25, the advertisement determination unit 2105 determines whether the personal information 2103 includes a purchase history indicating that the viewer has recently purchased a Queen (S3202).

If the personal information 2103 does not include the purchase history (No in S3202), the advertisement determination unit 2105 calculates the purchase cost of a Queen and generates an HTML file to be superimposed upon the television CM video 2003 as in FIGS. 7 and 25 (S3301). The advertisement determination unit 2105 then transmits the generated HTML file to the service provider A 2101.

On the other hand, if the personal information 2103 includes a purchase history indicating that the viewer has recently purchased a Queen, the advertisement determination unit 2105 transmits alternative advertisement selection information 2104 to the service provider A 2101 (S3302). The service provider A determines whether the received information is the alternative advertisement selection information 2104 (S3303). If the received information is the alternative advertisement selection information 2104 (Yes in S3303), the advertisement determination unit 2105 requests the advertisement information 612 from the service provider C 1902, the service provider D 1903 (not illustrated in FIG. 29), and the service provider E 1904 (S3304).

Each service provider transmits the advertisement information 612 (S3102), and the alternative information selection unit 1905 selects an alternative advertisement using the alternative advertisement selection information 2104 and the received advertisement information 612 (S3305). If the alternative advertisement is selected (Yes in S3306), the alternative information selection unit 1905 requests an HTML file of the selected alternative advertisement from the service provider (S3307). If the alternative advertisement is not selected (No in S3306), the alternative information generation unit 1906 generates a blank HTML file (S3308).

The alternative advertisement selection information 2104 is information used by an advertiser of the television CM video 2003 in order to select personalized information appropriate for the advertiser when the space is sold to another business owner. The automobile manufacturer A 2001 desires to receive money by selling the space for the television CM video 2003 for Queen to another business owner, but, at this time, it is desirable that personalized information of a rival automobile manufacturer not be displayed.

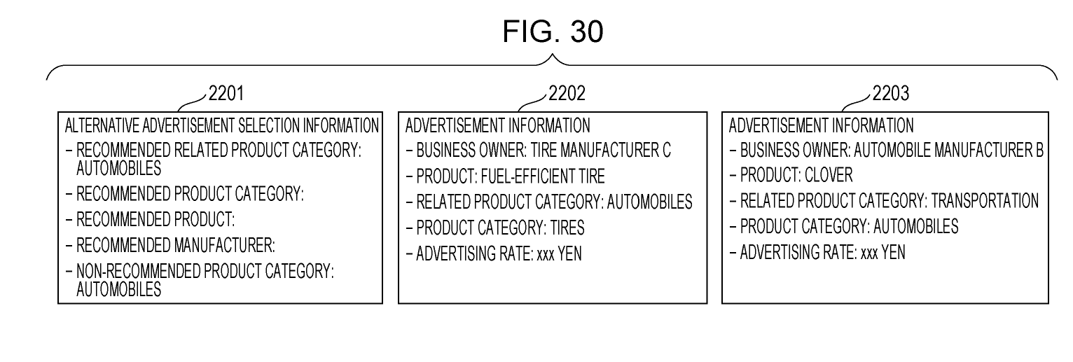

Here, because the automobile manufacturer A 2001 can select alternative personalized information in the case of the advertisement data providing system 1000b, display of personalized information of a rival automobile manufacturer can be avoided. On the other hand, in the case of the advertisement data providing system 1000c, since an advertising agency that is not related to the automobile manufacturer A 2001 selects alternative personalized information, it is possible that personalized information of a rival automobile manufacturer is undesirably selected. Therefore, the alternative advertisement selection information 2104 is used. The alternative advertisement selection information 2104 will be described hereinafter. FIG. 30 is a diagram illustrating a specific example of the alternative advertisement selection information 2104.

Alternative advertisement selection information 2201 illustrated in FIG. 30 includes, for example, information such as a recommended related product category, a recommended product category, a recommended product, a recommended manufacturer, and a non-recommended product category.

Here, the “product” refers to an advertised product. For example, in this example, it refers to Queen. The “product category” refers to a category including the advertised product. If the “product” is Queen, the “product category” is automobiles. The “related product category” refers to a field in which the advertised product is used. If the “product category” is automobiles, the “related product category” is transportation. If the “product category” is tires, the “related product category” is automobiles.

In the alternative advertisement selection information 2201, an attribute “recommended” or “non-recommended” is added to each piece of information. More specifically, in the alternative advertisement selection information 2201, the recommended related product category is automobiles, and the non-recommended product category is also automobiles. This means that products relating to automobiles (automobile products such as tires) are desirable in an advertisement of another business owner to be superimposed in the space of the television CM video 2003 for Queen, but an advertisement for an automobile itself is not desirable.

On the other hand, business owners (the service provider C 1902, the service provider D 1903, and the service provider E 1904) who desire to place alternative advertisements provide the advertisement information 612.

Advertisement information 2202 illustrated in FIG. 30 is an example of the advertisement information 612. The advertisement information 2202 indicates that the business owner of a target product is the tire manufacturer C, the product is a fuel-efficient tire, the related product is an automobile, and the product category is tires. The advertisement information 2202 satisfies conditions specified by the alternative advertisement selection information 2201. That is, the advertisement information 2202 might be selected as a candidate to be superimposed in the space of the television CM video 2003.

Advertisement information 2203 is another example of the advertisement information 612. The advertisement information 2203 indicates that the business owner of a target product is an automobile manufacturer B, the name of the product is Clover, the related product category is transportation, and the product category is automobiles. That is, an automobile called Clover manufactured by the automobile manufacturer B, which is a rival manufacturer of the automobile manufacturer A 2001, is an advertising target of the advertisement information 2203. Since the non-recommended product category of the alternative advertisement selection information 2201 is automobiles, the advertisement information 2203 does not satisfy the conditions specified by the alternative advertisement selection information 2201. Therefore, the advertisement information 2203 is not selected as the alternative advertisement.

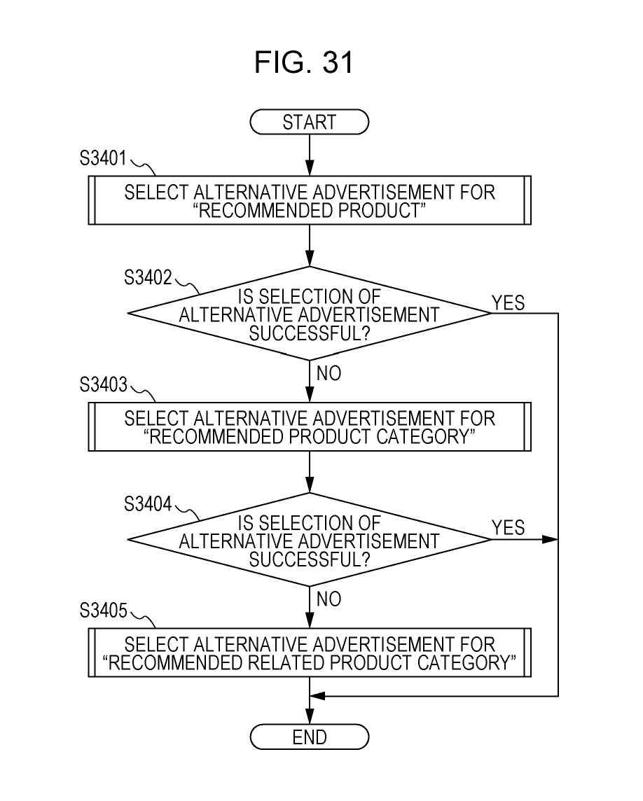

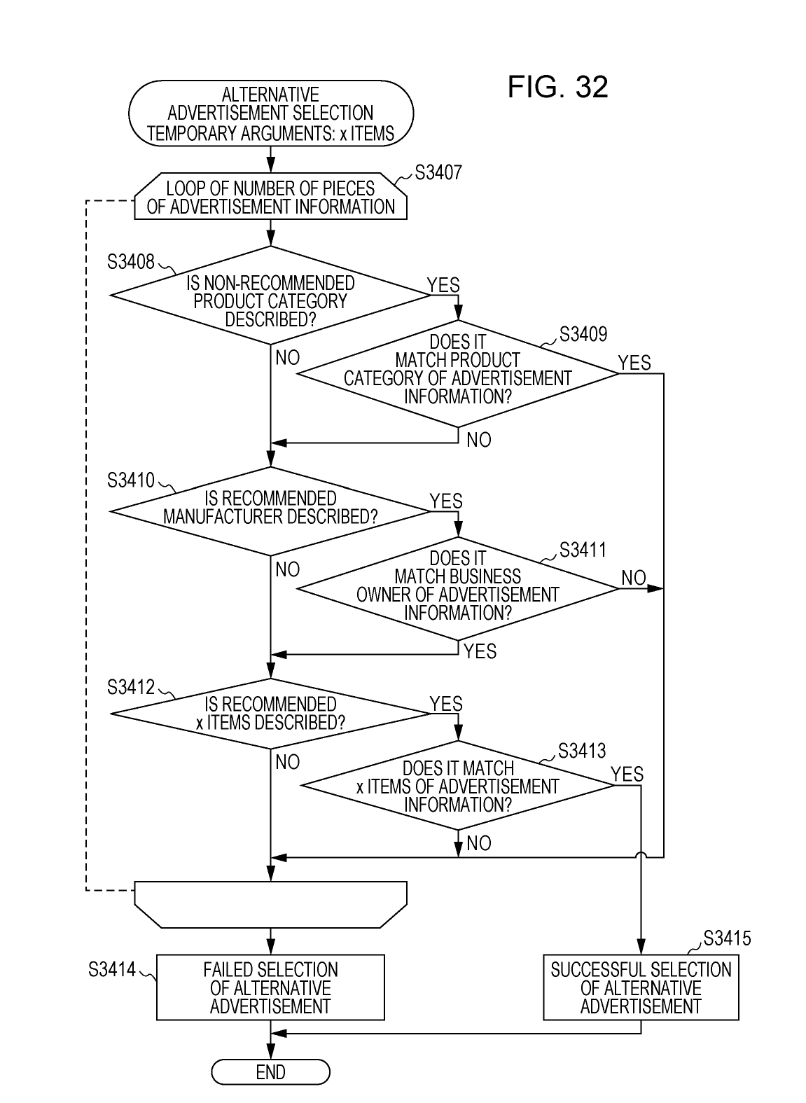

As described above, the alternative advertisement selection information 2201 and a method for selecting the advertisement information 612 (alternative advertisement) will be described with reference to FIG. 31. FIG. 31 is a flowchart illustrating the method for selecting the alternative advertisement. FIG. 32 is a flowchart illustrating a subroutine of the selection of the alternative advertisement. It is to be noted that FIG. 31 is a flowchart illustrating details of S3305 illustrated in FIG. 29.

As illustrated in FIG. 31, first, the alternative information selection unit 1905 selects the alternative advertisement for the “recommended product” (S3401). This selection is performed by calling the subroutine (FIG. 32) of the selection of the alternative advertisement.

If the selection of the alternative advertisement is successful (Yes in S3402), the alternative information selection unit 1905 skips other processes. If the selection of the alternative advertisement fails (No in S3402), the alternative information selection unit 1905 selects the alternative advertisement for the “recommended product category” in the same manner as above (S3403 and S3404). If the alternative advertisement cannot be selected, the alternative information selection unit 1905 selects the alternative advertisement for the “recommended related product category” in the same manner as above (S3405). That is, the flowchart of FIG. 31 indicates the priority of each parameter in the alternative advertisement selection information 2201.

Next, the flowchart of the subroutine of the selection of the alternative advertisement will be described with reference to FIG. 32. It is to be noted that in the flowchart of FIG. 32, whether the selection of the alternative advertisement has been successful or not is determined in accordance with whether the advertisement information 612 satisfies conditions of X recommended items.

As illustrated in FIG. 32, in the subroutine, a loop of all pieces of advertisement information is configured (S3407). In this loop, first, if the “non-recommended product category” is described in the alternative advertisement selection information 2201 (Yes in S3408) and a product category described as the “non-recommended product category” matches the product category in the target advertisement information 612 (Yes in S3409), the alternative information selection unit 1905 skips subsequent processes and performs a process for the next advertisement information 612.

Next, if the “non-recommended product category” is not described in the alternative advertisement selection information 2201 (No in S3408) and the product category described as the “non-recommended product category” does not match the product category in the target advertisement information 612 (No in S3409), the following process is performed.

If the “recommended manufacturer” is described in the alternative advertisement selection information 2201 (Yes in S3410) and a business owner described as the “recommended manufacturer” does not match the business owner in the target advertisement information 612 (No in S3411), the alternative information selection unit 1905 skips the processes and performs the process for the next advertisement information 612.

Finally, if the “recommended manufacturer” is not described in the alternative advertisement selection information 2201 (No in S3410) and the business owner described as the “recommended manufacturer” matches the business owner in the advertisement information 612 (Yes in S3411), the following process is performed.

If the X items specified as arguments are described in the alternative advertisement selection information 2201 (Yes in S3412) and description of the X items matches description of the corresponding items in the advertisement information 612 (Yes in S3413), the target advertisement information 612 is selected as the alternative advertisement. That is, the selection of the alternative advertisement is successful (S3415).

On the other hand, if the X items are not described in the alternative advertisement selection information 2201 (No in S3412) and the description of the X items does not match the description of the corresponding items in the advertisement information 612 (No in S3413), the alternative information selection unit 1905 skips the processes and performs the process for the next advertisement information 612.

If the loop of all the pieces of advertisement information is completed without selecting the alternative advertisement, the selection of the alternative advertisement fails (S3414).

It is to be noted that although the first advertisement information 612 that satisfies the conditions is selected as the alternative advertisement in the example illustrated in FIG. 32, for example, pieces of advertisement information 612 that satisfy the conditions may be collected, and a piece of advertisement information 612 whose advertising rate is the highest may be selected as the alternative advertisement.

As described above, according to the advertisement data providing system 1000c, the advertisement information 612 (advertisement) that satisfies the conditions specified by the alternative advertisement selection information 2201 is selected. As a result, the space of a television CM video that is no longer necessary can be sold to another business owner who is appropriate.

In particular, since a business owner such as an advertising agency can operate the service provider A 2101, which intermediates between an advertiser of a television CM video and another business owner, the advertiser of the television CM video need not search for or negotiate with another business owner who desires to place an advertisement.

On the other hand, if a business owner whose advertisement has been displayed as alternative personalized information pays an original advertiser of a television CM video an advertising rate and the service provider A 2101 that has acted as an intermediary a commission, the operation of the service provider A 2101 continues.

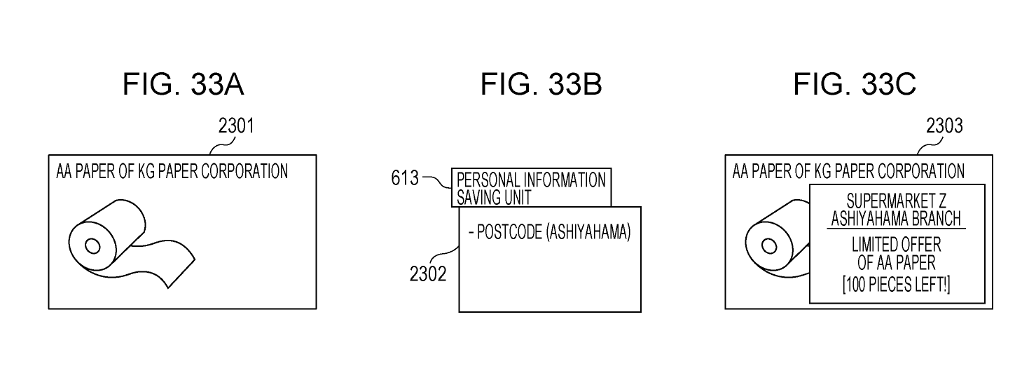

It is to be noted that the space of a television CM video that is no longer necessary to a certain viewer is sold to another business owner as the alternative advertisement. However, the alternative advertisement is not limited to this configuration. If it is determined that an advertising effect is not sufficient only with a television CM for a product of the company, personalized information of another company may be actively superimposed in order to further improve the advertising effect. FIGS. 33A to 33C are diagrams illustrating an example of a television CM video upon which an advertisement of another company is actively superimposed.

A television CM video 2301 (FIG. 33A) illustrated in FIGS. 33A to 33C is a television CM video created by KG Paper Corporation, which is a paper manufacturing company, in order to advertise a toilet paper called AA Paper. Although a certain advertising effect can be produced only by the television CM video 2301, the advertising effect of the television CM video 2301 is slightly insufficient if advertisements upon which videos based on personalized information, which have been described in the first to third embodiments, are superimposed become popular.

For example, in the case of the above-described television CM video for an automobile, information regarding a dealer located near the viewer is superimposed on the basis of the personalized information, in order to prompt the viewer to actually go to the shop and take purchase action. Such a television CM video can be realized since the automobile manufacturer operates a dealer network in its own scope of business, but KG Paper Corporation, which is a paper manufacturing company, is not operating specialty stores that sell only toilet paper. Therefore, it is difficult to superimpose information regarding stores based on personalized information upon a television CM video of the paper manufacturing company.

As described above, however, according to the advertisement data providing system 1000b and the advertisement data providing system 1000c, an advertiser can superimpose an advertisement (a video based on personalized information) of another business owner upon a television CM video thereof.

For example, as illustrated in FIGS. 33A to 33C, an advertisement of, among a group of supermarkets (business owners other than KG Paper Corporation) that deal in AA Paper, a nearest supermarket to the viewer can be selected using the personal information (postcode 2302) saved in the personal information saving unit 613 (FIG. 33B). Therefore, for example, a television CM video 2303 (FIG. 33C) upon which information regarding a limited offer of AA Paper is superimposed can be displayed.

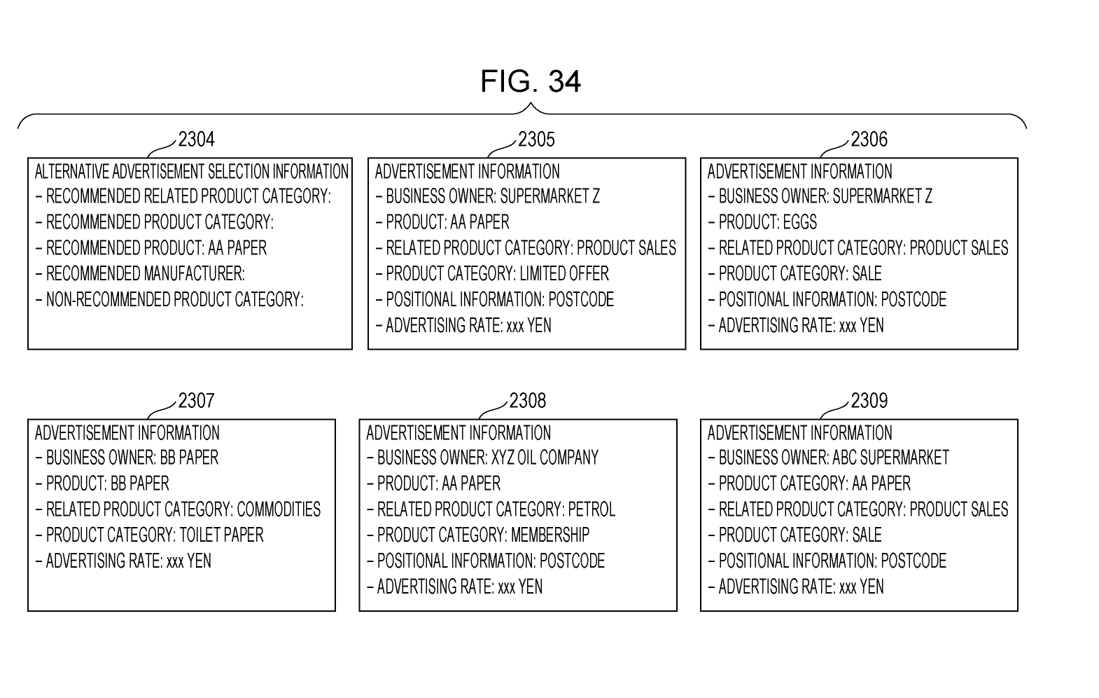

A specific example of the alternative advertisement selection information 2104 and the advertisement information 612 for producing the same effect as that produced by the television CM video 2303 illustrated in FIG. 33C will be described hereinafter. FIG. 34 is a diagram illustrating the specific example of the alternative advertisement selection information 2104 and the advertisement information 612.

In alternative advertisement selection information 2304 relating to a television CM video for AA Paper illustrated in FIG. 34, AA paper is specified as the recommended product. This means that advertisements for AA Paper placed by business owners other than KG Paper Corporation are recommended.

Advertisement information 2305 is advertisement information relating to a limited offer (product category) of AA Paper (product) at Supermarket Z, which is a supermarket business owner. Because the advertisement information 2305 satisfies the conditions specified by the alternative advertisement selection information 2304, the advertisement information 2305 can be selected as the alternative advertisement.

Advertisement information 2306 is advertisement information regarding product sales of Supermarket Z, but its target product is eggs. Because the advertisement information 2306 does not satisfy the conditions specified by the advertisement information 2305, the advertisement information 2306 is not selected as the alternative advertisement.

Advertisement information 2307 is advertisement information regarding a toilet paper called BB Paper. Because BB Paper is a product of a rival company of KG Paper Corporation, superimposition of the advertisement information 2307 upon the television CM video for AA Paper needs to be avoided, but because the target product of the advertisement information 2307 is not AA Paper, the advertisement information 2307 is not selected.

Advertisement information 2308 indicates that if the viewer buys a membership (product category) relating to gasoline fueling (related product category) at a gas station managed by an oil manufacturer called XYZ Oil Company, the viewer is given AA Paper (product). More specifically, if the advertisement information 2308 is selected, information indicating, for example, “Get OA Paper by registering as a member at XYZ Oil Company Ashiyahama Branch” is superimposed upon the television CM video.

Because the target product of the advertisement information 2308 is AA Paper, the advertisement information 2308 can be selected as the alternative advertisement. If KG Paper Corporation considers an advertisement that uses AA Paper as a free gift inappropriate as an advertisement superimposed upon the CM for AA Paper, product sales may be specified as an item of the recommended related product category of the alternative advertisement selection information 2304. As a result, only advertisement information whose target product is AA Paper is selected, and accordingly it is possible to prevent selection of the advertisement information 2308.

The advertisement information 2309 indicates sale information regarding AA Paper at a supermarket business owner called ABC Supermarket. Because the advertisement information 2309 satisfies the conditions specified by the alternative advertisement selection information 2304, the advertisement information 2309 can be selected as the alternative advertisement.

First, for example, the alternative information selection unit 1905 extracts the advertisement information 2305 and the advertisement information 2309 as selection candidates and finally selects either of them. For example, the alternative information selection unit 1905 may select advertisement information including positional information nearer to the viewer's home on the basis of a postcode (positional information) included in store information, or may select advertisement information whose advertising rate is higher. In addition, in the selection of advertisement information, the preferences of the viewer determined on the basis of personal information may be reflected, or advertisement information may be selected on the basis of a history of selected advertisement information.

### Fourth Embodiment

The technique described in all the above embodiments can be, for example, realized by the following types of cloud service. However, the types that realize the technique described in the above aspects are not limited to these.

### Service Type 1: In-House Data Center Type

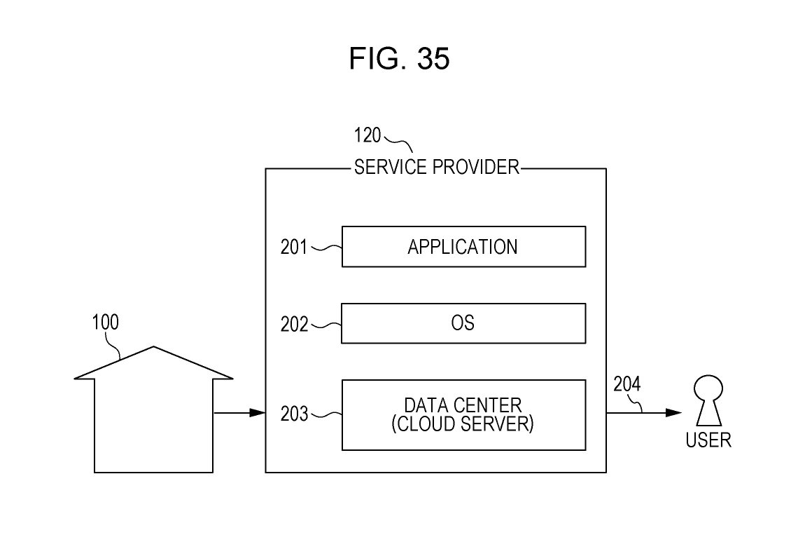

FIG. 35 illustrates Service Type 1 (in-house data center type). This type is a type in which the service provider 120 obtains information from the group 100 and provides a service for a user. In this type, the service provider 120 has the function of the data center operating company. That is, the service provider owns the cloud server 111 that manages big data. Therefore, there is no data center operating company.

In this type, the service provider 120 operates and manages a data center 203 (cloud server 111). In addition, the service provider 120 manages an operating system (OS) 202 and an application 201. The service provider 120 provides a service 204 using the OS 202 and the application 201 managed by the service provider 120.

### Service Type 2: IaaS Use Type

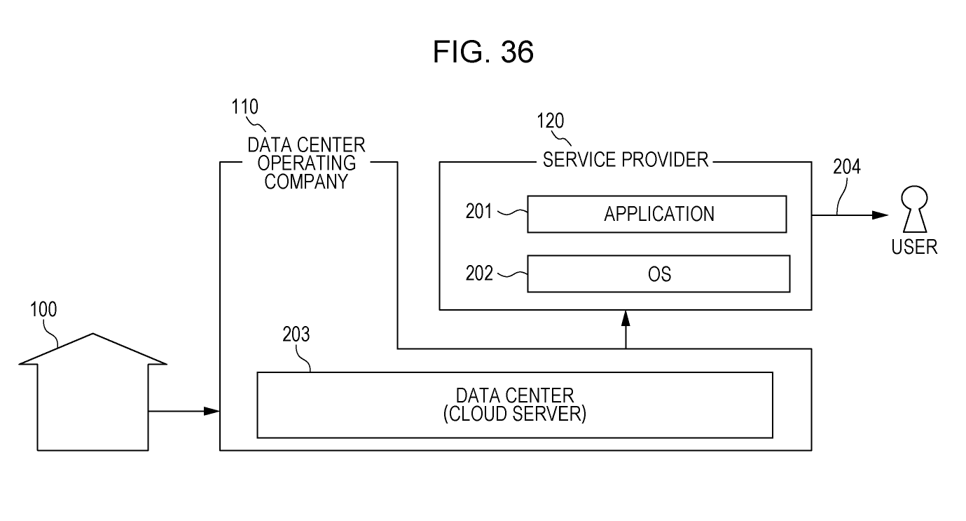

FIG. 36 illustrates Service Type 2 (IaaS use type). Here, IaaS is an abbreviation for Infrastructure as a Service, which is a cloud service providing model that provides an infrastructure for constructing and operating a computer system as a service through the Internet.

In this type, the data center operating company 110 operates and manages the data center 203 (cloud server 111). In addition, the service provider 120 manages the OS 202 and the application 201. The service provider 120 provides a service 204 using the OS 202 and the application 201 managed by the service provider 120.

### Service Type 3: PaaS Use Type

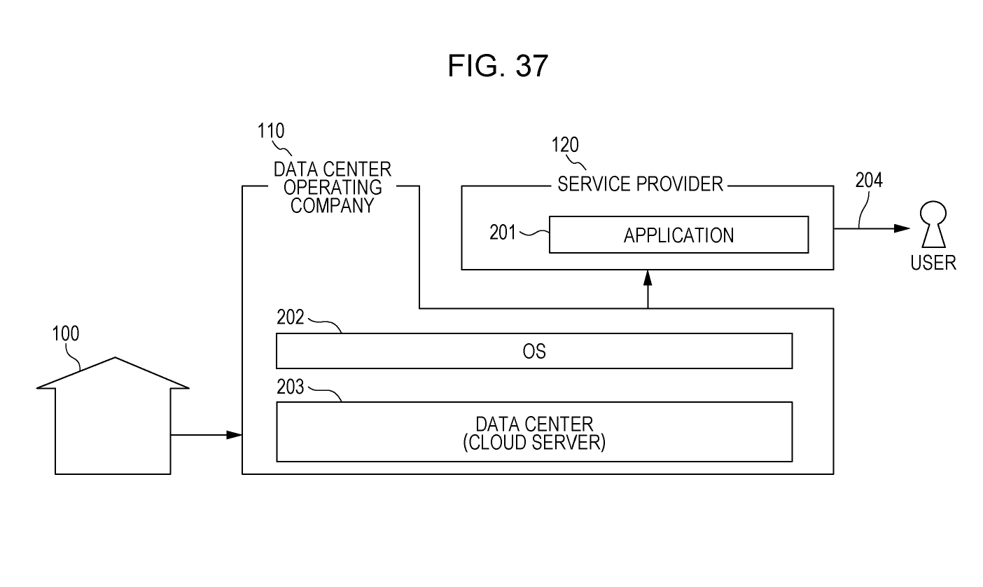

FIG. 37 illustrates Service Type 3 (PaaS Use Type). Here, PaaS is an abbreviation for Platform as a Service, which is a cloud service providing model that provides a platform that serves as a base for constructing and operating software as a service through the Internet.

In this type, the data center operating company 110 manages the OS 202 and operates and manages the data center 203 (cloud server 111). In addition, the service provider 120 manages the application 201. The service provider 120 provides a service 204 using the OS 202 managed by the data center operating company and the application 201 managed by the service provider 120.

### Service Type 4: SaaS Use Type

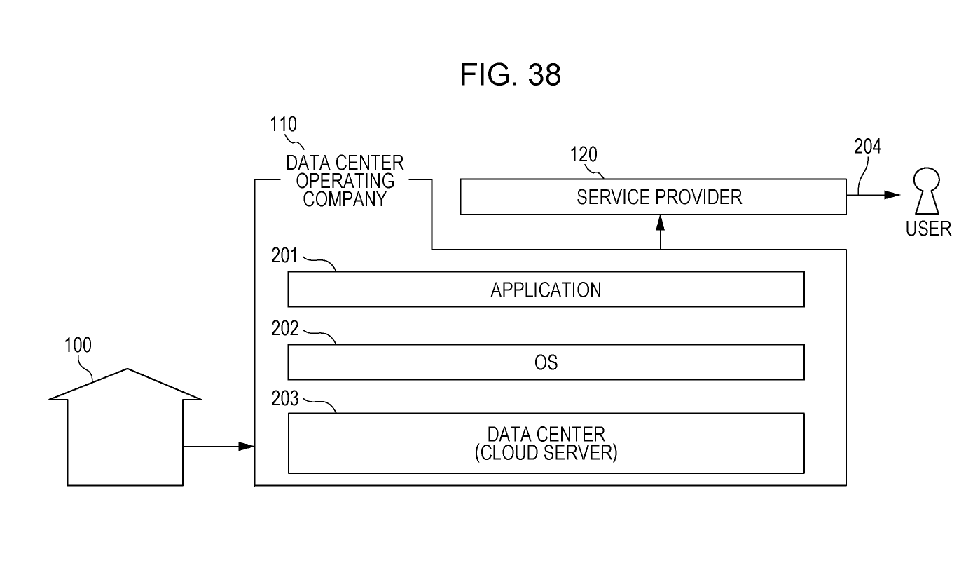

FIG. 38 illustrates Service Type 4 (SaaS Use Type). Here, SaaS is an abbreviation for Software as a Service, which is, for example, a cloud service providing model having a function of enabling a company or an individual (user) who does not own a data center (cloud server) to use, through a network such as the Internet, an application provided by a platform provider who owns a data center (cloud server).

In this type, the data center operating company 110 manages the application 201, manages the OS 202, and operates and manages the data center 203 (cloud server 111). In addition, the service provider 120 provides a service 204 using the OS 202 and the application 201 managed by the data center operating company 110.

In any of the above types, it is assumed that the service provider 120 provides a service. In addition, for example, the service provider or the data center operating company may develop an OS, an application, a database for big data, or the like by itself, or may outsource the development work to a third party.

### Other Embodiments

As described above, the first to fourth embodiments have been described as examples of the technique disclosed in the present application. However, the technique in the present invention is not limited to these examples, but may be applied to embodiments obtained by appropriately making changes, replacement, addition, omission, or the like to the above embodiments. In addition, new embodiments may be obtained by combining components described in the above embodiments.

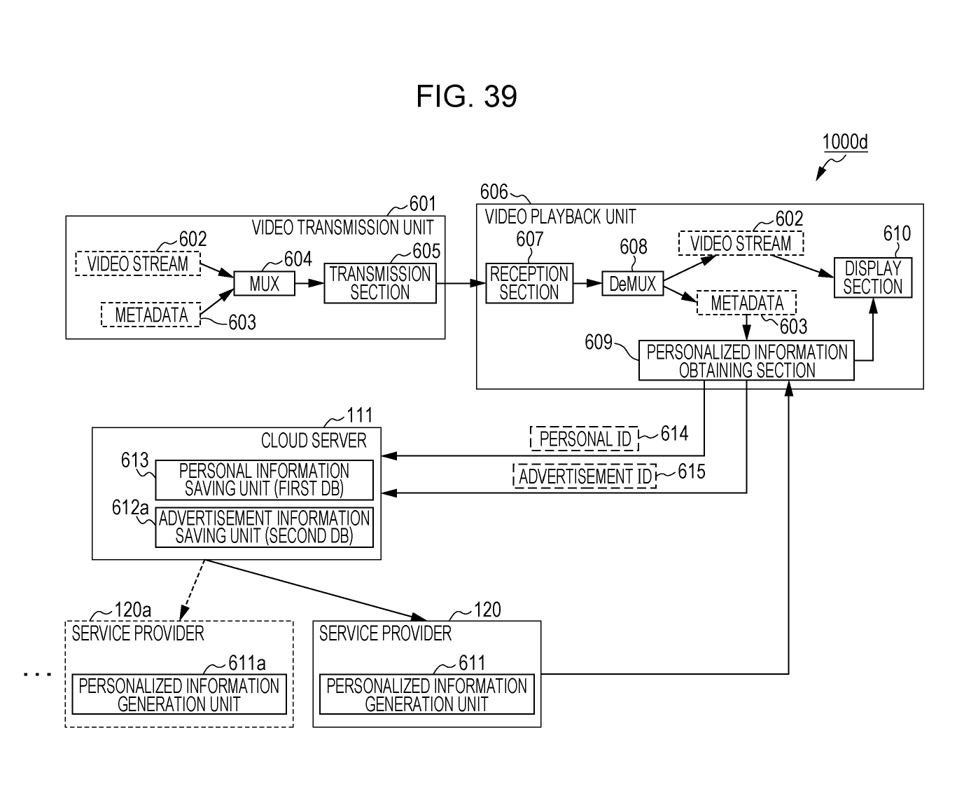

For example, although the service provider 120 obtains the personal ID 614 and the advertisement ID 615 in the first embodiment, the cloud server 111 may obtain the personal ID 614 and the advertisement ID 615, instead. FIG. 39 is a diagram illustrating a detailed configuration of an advertisement data providing system in which the cloud server 111 obtains the personal ID 614 and the advertisement ID 615.

In an advertisement data providing system 1000d illustrated in FIG. 39, two or more service providers 120 and 120a are included. The service provider 120 includes the personalized information generation unit 611, and the service provider 120a includes a personalized information generation unit 611a. In addition, the personal information saving unit 613 and the advertisement information saving unit 612a are provided in the cloud server 111.

The cloud server 111 obtains the personal ID 614 and the advertisement ID 615 from the video playback unit 606. Next, the cloud server 111 transmits the personal information saved in the personal information saving unit 613 and the advertisement information 612 saved in the advertisement information saving unit to the service provider 120 (or the service provider 120a) of an advertiser of advertisement information indicated by the advertisement ID. The personalized information generation unit 611 then generates personalized information using the received personal information and advertisement information 612.

According to the advertisement data providing system 1000d, the cloud server 111 can collectively manage personal information and advertisement information.

It is to be noted that, in the above embodiments, the components may be configured by dedicated hardware, or may be realized by executing software programs that suit the components. The components may be realized by a program execution unit such as a central processing unit (CPU) or a processor by reading and executing software programs recorded in a recording medium such as a hard disk or a semiconductor memory, instead.

In addition, in the above embodiment, a process executed by a particular processing unit may be executed by another processing unit, instead. In addition, order of a plurality of processes may be changed, or a plurality of processes may be executed in parallel with one another.

Although the method for providing advertisement data according to one or a plurality of aspects has been described above on the basis of the embodiments, the present invention is not limited to these embodiments. Embodiments obtained by modifying the above embodiments in various ways that can be conceived by those skilled in the art or embodiments constructed by combining components in different embodiments with one another may be included in the scope of the one or plurality of aspects, insofar as the scope of the present invention is not deviated from.

The present invention can improve an advertising effect while maintaining the content of advertisement data and is effective especially in displaying a television CM or the like.

What is claimed is:

1. A method for providing advertisement data in an advertisement data generation system connected, through a network, to a video playback apparatus that plays back the advertisement data, the method comprising:
receiving an advertisement identifier indicating the advertisement data and a user identifier indicating a user relating to the video playback apparatus from the video playback apparatus through the network;
obtaining first personal information corresponding to the user identifier using a first database that manages at least one piece of personal information;
obtaining first advertisement information corresponding to the advertisement identifier using a second database that manages at least one piece of advertisement information, the advertisement information being used for generating superimposition advertisement data, which is superimposed upon the advertisement data;
generating first superimposition advertisement data using the first personal information and the first advertisement information; and
providing the first superimposition advertisement data to the video playback apparatus through the network in order to cause the video playback apparatus to play back the advertisement data upon which the first superimposition advertisement data is superimposed.

2. The method for providing advertisement data according to claim 1,
wherein, if the first personal information is not obtained using the first database, the first superimposition advertisement data is generated only from the first advertisement information.

3. The method for providing advertisement data according to claim 1,
wherein the first superimposition advertisement data includes a value relating to an advertising target of the advertisement data, and
wherein the value is calculated on the basis of the first personal information.

4. The method for providing advertisement data according to claim 3,
wherein the advertising target is automobile insurance, and
wherein the value indicates an estimated cost of the automobile insurance for an automobile owned by the user.

5. The method for providing advertisement data according to claim 4,
wherein the first personal information includes at least one of following pieces of information: age of the user, a color of a driver's license of the user, and a main purpose of use when the user uses the automobile, and
wherein the estimated cost of the automobile insurance is calculated on the basis of at least one of following pieces of information included in the first personal information: a base insurance cost of the automobile insurance, the age of the user, the color of the driver's license of the user, and the main purpose of use when the user uses the automobile.

6. The method for providing advertisement data according to claim 3,
wherein the advertising target is an automobile, and
wherein the value indicates a purchase cost at a time when the user purchases the automobile that is the advertising target.

7. The method for providing advertisement data according to claim 6,
wherein the first personal information includes at least one of following pieces of information: a make and a model of an automobile owned by the user, a travel distance of the automobile owned by the user, a history of automobile accidents of the user, and a state of scratches of the automobile owned by the user, and
wherein the purchase cost is calculated on the basis of at least one of following pieces of information included in the first personal information: a base trade-in price corresponding to the make and the model of the automobile owned by the user, the travel distance of the automobile owned by the user, the history of automobile accidents of the user, and the state of scratches of the automobile owned by the user.

8. The method for providing advertisement data according to claim 3,
wherein the advertising target is an automobile, and
wherein the value indicates a predicted value of an improvement in a travel distance at a time when the user replaces the automobile owned by the user with the automobile that is the advertising target.

9. The method for providing advertisement data according to claim 8,
wherein the first personal information is a make and a model of the automobile owned by the user, and
wherein the predicted value of the improvement in the travel distance is calculated on the basis of a maximum travel distance of the automobile that is the advertising target and a maximum travel distance of the automobile owned by the user.

10. The method for providing advertisement data according to claim 1,
wherein an advertising target of the advertisement data includes a plurality of types of articles, and
wherein the first superimposition advertisement data indicates one of the plurality of types of articles to be recommended to the user.

11. The method for providing advertisement data according to claim 10,
wherein the first personal information includes information regarding a type and a model number of a home appliance owned by the user and a television viewing history of the user, and
wherein the article to be recommended to the user is determined on the basis of the type and the model number of the home appliance owned by the user and the television viewing history of the user.

12. The method for providing advertisement data according to claim 1,
wherein an advertising target of the advertisement data includes a dealer,
wherein the dealer includes a plurality of local stores, and
wherein the first superimposition advertisement data indicates a name of one of the plurality of local stores nearest to the user's home and positional information regarding the nearest store.

13. The method for providing advertisement data according to claim 12,
wherein the first personal information includes information regarding an address of the user's home,
wherein the nearest store is selected on the basis of the address of the user's home,
wherein the positional information is map information including a position of the nearest store on a map, and
wherein map information including the position of the nearest store is obtained using a third database that manages map data.

14. The method for providing advertisement data according to claim 1,
wherein a provider of the advertisement data and a provider of the superimposition advertisement data are the same.

15. The method for providing advertisement data according to claim 1,
wherein a provider of the advertisement data and a provider of the superimposition advertisement data are different from each other.

16. A method for providing advertisement data in an advertisement data generation system connected, through a network, to a video playback apparatus that plays back the advertisement data, the method comprising:
receiving an advertisement identifier indicating the advertisement data and viewing state information including a time and a position at which the advertisement data is watched at the video playback apparatus, from the video playback apparatus through the network;
obtaining first advertisement information corresponding to the advertisement identifier using a first database that manages at least one piece of advertisement data, the advertisement information being used for generating superimposition advertisement data, which is superimposed upon the advertisement data;
generating first superimposition advertisement data using the first advertisement information and the viewing state information; and
providing the first superimposition advertisement data to the video playback apparatus through the network in order to cause the video playback apparatus to play back the advertisement data upon which the first superimposition advertisement data has been superimposed.

17. The method for providing advertisement data according to claim 16,
wherein the advertisement data includes first time information regarding an advertising target,
wherein the first superimposition advertisement data includes second time information regarding the advertising target, and
wherein the first time information and the second time information are different from each other.

18. The method for providing advertisement data according to claim 17,
wherein the advertising target includes a dealer,
wherein the advertisement data includes information regarding a first event provided by the dealer and the first time information indicating a period in which the first event is provided,
wherein the first superimposition advertisement data includes information regarding a second event provided by the dealer and the second time information indicating a period in which the second event is provided, and
wherein the first event and the second event are different from each other.

19. The method for providing advertisement data according to claim 18,
wherein the dealer includes a plurality of local stores, and
wherein the first superimposition advertisement data includes a name of one of the plurality of local stores nearest to a point at which the advertisement data is watched and positional information regarding the nearest store.

20. The method for providing advertisement data according to claim 19,
wherein the nearest store is selected using the viewing state information,
wherein the positional information is map information including a position of the nearest store on a map, and
wherein the map information including the position of the nearest store is obtained using a second database that manages map data.

21. The method for providing advertisement data according to claim 20, further comprising:
receiving a user identifier indicating a user relating to the video playback apparatus from the video playback apparatus through the network;
obtaining first personal information corresponding to the user identifier using a third database that manages at least one piece of personal information; and
generating the first superimposition advertisement data using the first personal information.

22. The method for providing advertisement data according to claim 18,
wherein the dealer is an automobile dealer.
